(19) United States
(12) Patent Application Publication
(10) Pub. No.: US 2020/0069517 A1
(43) Pub. Date: Mar. 5, 2020

(54) SUBCUTANEOUS TISSUE THERAPY TREATMENT DEVICE

(71) Applicant: Akiharu IWAGAMI, Kumamoto-shi, Kumamoto (JP)

(72) Inventor: Akiharu IWAGAMI, Kumamoto-shi, Kumamoto (JP)

(21) Appl. No.: 16/607,501

(22) PCT Filed: Apr. 27, 2018
(86) PCT No.: PCT/JP2018/017235

§ 371 Date: Oct. 23, 2019

(30) Foreign Application Priority Data
Apr. 27, 2017 (JP) 2017-088282

(51) Int. Cl. A61H 39/04

(52) U.S. Cl. CPC A61H 39/04; A61H 2201/0153; A61H 2205/025; A61H 2205/021; A61H 2201/1253

(57) ABSTRACT

A subcutaneous tissue therapy treatment device is formed of: a rod-shaped grip portion; a bifurcated treatment portion for a neck and a head which is formed on a distal end of the grip portion; and a grasp portion which is formed on a rear end of the grip portion, and the bifurcated treatment portion for a neck and a head is formed by combining a lower protrusion positioned closer to the neck during treatment and an upper protrusion positioned closer to a vertex region during treatment to each other, an upper protrusion front end and a lower protrusion front end of the bifurcated treatment portion are formed with a distance which strides over meridians distributed in respective surface curved areas of respective zones in a case where a surface of a cranial bone is divided into four zones ranging from an occipital region to a frontal region.

### TECHNICAL FIELD

The present invention relates to a subcutaneous tissue therapy treatment device capable of increasing immunity by applying a stimulus to subcutaneous tissues in four zones ranging from a neck to a frontal muscle or temporal muscles simply without requiring expertise by using a bifurcated treatment portion of the therapy treatment device for a neck and a head where a surface of a cranial bone ranging from the neck to the frontal muscle or the temporal muscles is divided into four zones with respect to an occipital bone, and the bifurcated treatment portion holds widths corresponding to widths of the respective zones.

### BACKGROUND ART

Various kinds of muscles, nerves, and lymphatic vessels run through a part of a human body ranging from a neck to a frontal region or temporal muscles. Particularly, in an oriental medicine, meridians which connect scattered and concentrated acupuncture points (meridian points) to each other run through the part. Conventionally, applying a stimulus to such muscles, nerves, lymphatic vessels, and meridians has been actively used as a therapeutic method for obtaining a medical effect such as the improvement of a blood flow, a relaxation effect which relaxes a tension of mind and body, and a massaging effect such as kneading and alleviating stiffness. As such a method, there has been known a so-called acupressure therapy where a therapist applies a stimulus to meridians, neuromusculars, muscles and the like of such portions and diagnosis such portions using his fingers.

An effect which such a therapy applies to a patient differs depending on a technique of a therapist. Accordingly, such a therapy has a drawback that it is impossible to ask many therapists to have a uniform therapeutic technique. Further, a simple acupressure and kneading operation performed for a long time impose a large physical burden on the therapist. Further, it is necessary for a therapist to perform practice and exercising for a long period for acquiring acupressure skill at a predetermined level through training.

In view of the above, to overcome these drawbacks, there has been proposed a technique where an acupressure device having a fixed shape is provided, and an acupuncture point or a predetermined muscle of a human body is pressed using the device in place of fingers of a therapist).

It is necessary for such an acupressure device to have the device structure of a fixed shape where pressing which is substantially equal to pressing by fingers properly applied to acupressure places is applied. With respect to the shape of such an acupressure device, many patent applications have been made and many patents have been registered on design and shape of such an acupressure device (for example, see patent literature 1.

### CITATION LIST

### Patent Literature

PTL 1: JP H10-43270 A

### SUMMARY OF INVENTION

### Technical Problem

The acupressure device formed in the fixed shape as described above is provided for acquiring an effect substantially equal to a finger pressure by pressing a protruding portion of a plate body formed in a cloud shape, for example, to an affected part and by adjusting a pressing force. Alternatively, such an acupressure device may be a formed body which traces the shape of an acupressure place of an affected part or may be a formed body where a large number of protruding portions are formed so as to finish therapy within a short time by simultaneously pressing the protruding portions to a plurality of affected parts.

There has been also proposed an acupressure device where, in an in-use mode of the device, a therapist inserts his fingers into a plurality of finger holes formed in a center portion of a device body, grips the whole device with his palm, and presses a protruding portion of the device having a fixed shape to an affected part thus effectively transmitting a pressing stress to an affected part from the device.

However, these acupressure devices have advantages and disadvantages. That is, even when a therapist grips the acupressure device body with his palm and presses the acupressure device body to an affected body, a pressing force of a palm of the therapist is not effectively transmitted to the device body and hence, a pressing stress is not sufficiently transmitted to the affected part. To the contrary, an extra force is necessary in performing such a treatment and hence, a physical burden imposed on the therapist is increased thus giving rise to a drawback that it is difficult for the therapist to perform the treatment for a long time.

Further, in applying a stimulus therapy to a cranial bone of a head, since the shape of the acupressure device is not formed such that the acupressure device can be used in common on substantially the entire surface of the head, it is necessary to prepare a large number of acupressure devices having different shapes corresponding to positions of affected parts of the head. Accordingly, there exist drawbacks that the acupressure therapy becomes cumbersome and the therapeutic devices also become expensive. As described above, there has not existed a treatment device where the treatment device can effectively perform a stimulus treatment of subcutaneous tissues simply and with a least physical burden in a wide range from an occipital region to a vertex region using a single treatment device.

### Solution to Problem

To overcome the above-mentioned drawbacks of the prior art, this invention provides a subcutaneous tissue therapy treatment device, wherein a treatment device body is formed of: a grip portion; a bifurcated treatment portion for a neck and a head which is formed on a distal end of the grip portion; and a grasp portion which is formed on a rear end of the grip portion, and the bifurcated treatment portion for a neck and a head is formed by combining a lower protrusion positioned closer to the neck during treatment and an upper protrusion positioned closer to a vertex region during treatment to each other, an upper protrusion front end and a lower protrusion front end of the bifurcated treatment portion are formed with a distance which allows fixed placement of the upper protrusion front end and the lower protrusion front end striding over of respective zones in a case where a surface of a cranial bone is divided into four zones ranging from an occipital region to a frontal region, and in a state where, out of the four zones defined by dividing the cranial bone ranging from the occipital region to frontal region, assuming a surface curved area which is a suboccipital muscles portion which covers a cranial base between left and right temporal bones in layers and is positioned between an inferior nuchal line of nuchal lines and a superior nuchal line of the nuchal lines as a first zone formed by dividing the surface of the cranial bone, assuming a surface curved area which is an occipital muscle portion and an epicranial aponeurosis portion which cover a calvaria rear half portion between the left and right temporal bones and is defined by respective areas consisting of an area between the superior nuchal line of the nuchal lines and the frontal muscle and an area between the left and right temporal bones as a second zone formed by dividing the surface of the cranial bone, assuming a surface curved area which is defined by a frontal muscle portion which covers a calvaria front half portion between the left and right temporal bones as a third zone formed by dividing the surface of the cranial bone, and assuming a surface curved area which is defined by temporal muscle portions which cover the left and right temporal bones as a fourth zone formed by dividing the surface of the cranial bone, a distance between the upper and lower protrusion front ends of the bifurcated treatment portion satisfies respective distances consisting of: a distance where the distance strides over a boundary line between the first zone and the second zone, the lower protrusion is brought into contact with a meridian in the first zone and the upper protrusion is brought into contact with the meridian in the second zone; a distance where the upper and lower protrusions are brought into contact with the front and rear meridians scattered in respective longitudinal directions in an area of the second zone; a distance where the lower protrusion is brought into contact with the meridian in the third zone while displacing the upper protrusion along a boundary line between the second zone and the third zone; a distance where the lower protrusion is brought into contact with the meridian in the fourth zone while displacing the upper protrusion along a boundary line between the second zone and the fourth zone and the like.

The lower protrusion of the bifurcated treatment portion is formed in a shape protruding longer in a distal end direction than the upper protrusion, and the distance between the upper and lower protrusion front ends of the bifurcated treatment portion satisfies respective distances consisting of:

a distance where the distance strides over a boundary line between the first zone and the second zone, the longer lower protrusion is brought into contact with the meridian in the first zone and the shorter upper protrusion is brought into contact with the meridian in the second zone; a distance where the upper and lower protrusions are brought into contact with the front and rear meridians scattered in the respective longitudinal directions in an area of the second zone; a distance where the longer lower protrusion is brought into contact with the meridian in the third zone while displacing the shorter upper protrusion along a boundary line between the second zone and the third zone; a distance where the longer lower protrusion is brought into contact with the meridian in the fourth zone while displacing the shorter upper protrusion along a boundary line between the second zone and the fourth zone and the like.

The upper protrusion of the bifurcated treatment portion is made to protrude along an axial direction of the grip portion, and the lower protrusion is provided with an inclination of approximately 40° to 60° with respect to the axial direction of the grip portion.

The upper and lower protrusions of the bifurcated treatment portion are formed in a flat shape, and a center portion of a flat distal end edge in a wall thickness direction is formed in a recessed shape thus forming both left and right side protruding edge portions on both flat side surfaces.

The subcutaneous tissue therapy treatment device is configured such that when a therapist grips the grip portion having a rod shape between the bifurcated treatment portion and the grasp portion using a length of the grip portion as a width of a palm gripping part of the therapist, both end surfaces of the palm gripping part in a width direction are brought into close contact with the bifurcated treatment portion and the grasp portion.

The bifurcated treatment portion is gradually sharpened toward the distal end, and a most distal end portion is formed in a round shape as viewed in a plan view and in a shape where wall thickness is gradually decreased toward the distal end as viewed in a side view.

A roughened surface which increases a slide friction is formed on a functional surface of the bifurcated treatment portion formed on the front end of the grip portion.

The subcutaneous tissue therapy treatment device is configured such that the treatment device body is made of a resin, and is capable of performing stable treatment while maintaining a considerable weight during a treatment operation.

### Advantageous Effects of Invention

According to the invention described in claim 1, the bifurcated treatment portion is basically formed so as to perform the treatment which applies a pressing stimulus to an affected part while tracing a spherical surface of a cranial bone. Accordingly, a direction along which a largest pressing stress is applied to the cranial bone can be set to a direction perpendicular to a head of a patient in a face-down state. That is, in a state where the head of the patient in a standing posture is divided into four zones in a horizontal direction of the head and hence, a stimulus therapy can be applied to subcutaneous tissues in the four zones of the cranial bone ranging from a rear surface portion to a vertex region.

In the case where the cranial bone is divided into four zones ranging from the occipital region to the frontal region, a surface curved area which is a suboccipital muscles portion which covers a cranial base between left and right temporal bones in layers and is positioned between an inferior nuchal line of nuchal lines and a superior nuchal line of the nuchal lines is assumed as a first zone formed by dividing the surface of the cranial bone, a surface curved area which is an occipital muscle portion and an epicranial aponeurosis portion which cover a calvaria rear half portion between the left and right temporal bones and is defined by respective areas consisting of an area between the superior nuchal line of the nuchal lines and the frontal muscle and an area between the left and right temporal bones is assumed as a second zone formed by dividing the surface of the cranial bone, a surface curved area which is defined by a frontal muscle portion which covers a calvaria front half portion between the left and right temporal bones is assumed as a third zone formed by dividing the surface of the cranial bone, and a surface curved area which is defined by temporal muscle portions which cover the left and right temporal bones is assumed as a fourth zone formed by dividing the surface of the cranial bone.

When the treatment device body is pressed to such respective zones vertically so that a pressing stress is applied in an axial direction of the grip portion, the pressing stress is uniformly transmitted to an affected part by way of the upper and lower protrusions whereby it is possible to acquire an advantageous effect that a stimulus can be applied to meridians of the subcutaneous tissues on the respective upper and lower edges or the like of each zone.

That is, in this invention, even when an inputting direction is perpendicular to a head in a face-down state which is an approximately spherical body, the upper and lower protrusion distal ends are brought into close contact with the affected part of the head so that it is possible to provide the bifurcated treatment portion structure which can exhibit a stimulus stress as maximum as possible.

Further, in the case where a stimulus is applied to four zones of the head of a patient in a face-down state in a direction perpendicular to the head of a patient from a rear surface of the cranial bone, a surface shape of the head is disposed remote from the treatment device body toward a lower edge line of each zone.

That is, assuming that the upper and lower protrusions have the same length, when the treatment device body takes a posture perpendicular to each zone, the lower protrusion directed toward a lower edge of each zone is positioned remoter than the upper protrusion directed toward the upper edge line of each zone.

Accordingly, to bring the respective protrusions into contact with an affected part of the cranial bone uniformly without fail, it is indispensable to set the lower protrusion longer than the upper protrusion.

As a shape which conforms to such a logic, in the invention according to claim 2, the lower protrusion of the bifurcated treatment portion is formed in a shape where the lower protrusion is made to protrude longer than the upper protrusion in a distal end direction. That is, the bifurcated treatment portion for a neck and a head is formed by combining the lower protrusion positioned remoter from a cranial bone during treatment and the upper protrusion positioned closer to the cranial bone during treatment. As a result, it is possible to acquire an advantageous effect that, by pressing the rod-shaped grip portion in a direction perpendicular to the respective zones of a cranial bone of a patient in a face-down state, the upper and lower protrusions which differ in a distal end length can apply a stimulus to subcutaneous cells disposed at different positions as effectively and uniformly as possible.

Further, to enable a distance between front ends of the upper and lower protrusions of the bifurcated treatment portion to be used in common among four zones, the distance between the upper and lower protrusion front ends of the bifurcated treatment portion satisfies respective distances consisting of: a distance where the distance strides over a boundary line between the first zone and the second zone, the longer lower protrusion is brought into contact with the meridian in the first zone and the shorter upper protrusion is brought into contact with the meridian in the second zone; a distance where the upper and lower protrusions are brought into contact with the front and rear meridians scattered in the respective longitudinal directions in an area of the second zone; a distance where the longer lower protrusion is brought into contact with the meridian in the third zone while displacing the shorter upper protrusion along a boundary line between the second zone and the third zone; a distance where the longer lower protrusion is brought into contact with the meridian in the fourth zone while displacing the shorter upper protrusion along a boundary line between the second zone and the fourth zone and the like. Accordingly, it is possible to apply a stimulus to the substantially entire necessary subcutaneous tissues of a cranial bone using only one treatment device and hence, treatment efficiency can be enhanced and, at the same time, a particular skill becomes unnecessary so that a large number of therapists can apply a common treatment technique at a predetermined level to patients.

According to the invention described in claim 3, it is possible to acquire an advantageous effect that, when a pressing stress is applied in an axial direction of the grip portion by pressing the treatment device body to each zone vertically, the pressing stress can be transmitted to affected parts more uniformly by way of the upper and lower protrusions thus applying a stimulus to meridians of the subcutaneous tissues at upper and lower edges of each zone.

According to the invention described in claim 4, it is possible to acquire an advantageous effect that a friction resistance is increased corresponding to the increase of the number of skin contact points on the surface of the cranial bone during treatment and hence, a stable pressing force can be applied to an affected part.

According to the invention described in claim 5, a width of the rounded palm gripping part for gripping the rod-shaped grip portion falls between the bifurcated treatment portion and the grasp portion in a state where the palm gripping part is brought into close contact with the bifurcated treatment portion and the grasp portion. Accordingly, a therapist can sufficiently generate a gripping stress at his palm gripping part and can transmit a pressing force to an affected part as he wishes by way of the treatment device. Accordingly, the therapist can apply a stimulus to a subcutaneous tissue of an affected part with certainty.

According to the invention described in claim 6, it is possible to acquire an advantageous effect that the bifurcated treatment portion can be properly and fixedly placed on treatment effective points of an affected part, and the bifurcated treatment portion can effectively apply its function to subcutaneous tissues of an affected part without applying an undesired excessive stimulus to the affected part.

According to the invention described in claim 7, a roughened surface which increases a slide friction is formed on a functional surface of the bifurcated treatment portion formed on the front end of the grip portion. Accordingly, when the treatment device is pressed to a surface of an affected part, there is no possibility that the treatment device slides and moves away and hence, it is possible to acquire an advantageous effect that the treatment device can be positioned at subcutaneous tissues of an affected part with certainty thus making the treatment device efficiently and functionally perform a treatment operation.

According to the invention described in claim 8, the subcutaneous tissue therapy treatment device is configured such that the treatment device body is made of a resin, and is capable of performing stable treatment while maintaining a considerable weight during a treatment operation. Accordingly, it is possible to acquire an advantageous effect that gripping of the treatment device and a treatment operation can be performed easily due to its own weight of the treatment device body.

### BRIEF DESCRIPTION OF DRAWINGS

FIG. 1 is a front view of a subcutaneous tissue therapy treatment device according to this embodiment.

FIG. 2(a) and FIG. 2(b) are front views of the subcutaneous tissue therapy treatment device according to this embodiment.

FIG. 3(a) and FIG. 3(b) are a front view and a plan view of the subcutaneous tissue therapy treatment device according to this embodiment.

FIG. 4 is an explanatory view showing an in-use example of the subcutaneous tissue therapy treatment device according to this embodiment.

FIG. 5 is an explanatory view showing an in-use example of the subcutaneous tissue therapy treatment device according to this embodiment.

FIG. 6 is an explanatory view showing an in-use example of the subcutaneous tissue therapy treatment device according to this embodiment.

FIG. 7 is an explanatory view showing an in-use example of the subcutaneous tissue therapy treatment device according to this embodiment.

FIG. 8 is a front perspective view of a cranial bone where a surface of the cranial bone is divided into zones.

FIG. 9 is a back perspective view of the cranial bone where the surface of the cranial bone is divided into zones.

FIG. 10 is a front view of the cranial bone where the surface of the cranial bone is divided into zones.

FIG. 11 is a back view of the cranial bone where the surface of the cranial bone is divided into zones.

FIG. 12 is a side view of the cranial bone where the surface of the cranial bone is divided into zones.

FIG. 13 is an enlarged front view of a bifurcated treatment portion of the subcutaneous tissue therapy treatment device according to this embodiment.

FIG. 14(a), FIG. 14(b), and FIG. 14(c) are a front view, a plan view, and a cross-sectional view showing a modification of the subcutaneous tissue therapy treatment device according to this embodiment.

FIG. 15(a) and FIG. 15(b) are a perspective view and a plan view showing a modification of the subcutaneous tissue therapy treatment device according to this embodiment.

FIG. 16(a) and FIG. 16(b) are a perspective view and a plan view showing a modification of the subcutaneous tissue therapy treatment device according to this embodiment.

FIG. 17 is an explanatory view showing a gripping state of the subcutaneous tissue therapy treatment device according to this embodiment.

FIG. 18 is an explanatory view showing a gripping state of the subcutaneous tissue therapy treatment device according to this embodiment.

FIG. 19 is an explanatory view showing a gripping state of the subcutaneous tissue therapy treatment device according to this embodiment.

FIG. 20 is an explanatory view showing an in-use example of the subcutaneous tissue therapy treatment device according to this embodiment.

FIG. 21 is an explanatory view showing an in-use example of the subcutaneous tissue therapy treatment device according to this embodiment.

FIG. 22 is an explanatory view showing an in-use example of the subcutaneous tissue therapy treatment device according to this embodiment.

### DESCRIPTION OF EMBODIMENTS

The gist of this invention lies in a subcutaneous tissue therapy treatment device, wherein a treatment device body is formed of: a grip portion; a bifurcated treatment portion for a neck and a head which is formed on a distal end of the grip portion; and a grasp portion which is formed on a rear end of the grip portion, and the bifurcated treatment portion for a neck and a head is formed by combining a lower protrusion positioned closer to the neck during treatment and an upper protrusion positioned closer to a vertex region during treatment to each other, an upper protrusion front end and a lower protrusion front end of the bifurcated treatment portion are formed with a distance which allows fixed placement of the upper protrusion front end and the lower protrusion front end striding over both side edge lines of respective zones in a case where a surface of a cranial bone is divided into four zones ranging from an occipital region to a frontal region, and in a state where, out of the four zones defined by dividing the cranial bone ranging from the occipital region to frontal region, assuming a surface curved area which is a suboccipital muscles portion which covers a cranial base between left and right temporal bones in layers and is positioned between an inferior nuchal line of nuchal lines and a superior nuchal line of the nuchal lines as a first zone formed by dividing the surface of the cranial bone, assuming a surface curved area which is an occipital muscle portion and an epicranial aponeurosis portion which cover a calvaria rear half portion between the left and right temporal bones and is defined by respective areas consisting of an area between the superior nuchal line of the nuchal lines and the frontal muscle and an area between the left and right temporal bones as a second zone formed by dividing the surface of the cranial bone, assuming a surface curved area which is defined by a frontal muscle portion which covers a calvaria front half portion between the left and right temporal bones as a third zone formed by dividing the surface of the cranial bone, and assuming a surface curved area which is defined by temporal muscle portions which cover the left and right temporal bones as a fourth zone formed by dividing the surface of the cranial bone, a distance between the upper and lower protrusion front ends of the bifurcated treatment portion satisfies respective distances consisting of: a distance where the distance strides over a boundary line between the first zone and the second zone, the lower protrusion is brought into contact with a meridian in the first zone and the upper protrusion is brought into contact with the meridian in the second zone; a distance where the upper and lower protrusions are brought into contact with the front and rear meridians scattered in respective longitudinal directions in an area of the second zone; a distance where the lower protrusion is brought into contact with the meridian in the third zone while displacing the upper protrusion along a boundary line between the second zone and the third zone; a distance where the lower protrusion is brought into contact with the meridian in the fourth zone while displacing the upper protrusion along a boundary line between the second zone and the fourth zone and the like.

The subcutaneous tissue therapy treatment device according to this invention fundamentally differs from a therapy treatment device which intends to acquire a massaging effect by simply performing “pressing” and “rubbing” such as a massage device used in general. That is, the subcutaneous tissue therapy treatment device according to this invention is a device dedicated for stretching, expanding and pressing head subcutaneous tissues where tissues below a skin is compressed without moving away from a pressing direction by “pressing”, “rotating” or “pulling” “the skin under a stretched state” so that tissues, lymph, muscle ligament and the like are activated.

A scalp is formed of five divided parts consisting of a skin, a connective tissue, an epicranial aponeurosis, a loose areolar connective tissue, and a pericranium. The skin is formed of divided parts consisting of an epidermal tissue, a dermal tissue, a subcutaneous tissue.

The epidermal tissue is formed of a horny layer, a granular layer, a prickle cell layer, and a basal layer. The dermal tissue is formed of a papillary layer, a subpapillary layer, a reticular layer, a blood vessel, a nerve, and accessory organs such as a sebaceous gland and a sweat gland. The subcutaneous tissue is a tissue having a large amount of fat and capillaries, and plays a role of protecting tissues by a cushioning function which the subcutaneous tissue has.

Most of the vertex region disposed below the scalp is covered by the epicranial aponeurosis. The vertex region has a thinner and harder connective tissue than other parts of a human body and hence, an acupressure force generated by fingers is transmitted only to the skin.

On the other hand, with the use of subcutaneous tissue therapy treatment device having a large friction coefficient, a pressing force applies a pressing stimulus to useful functional parts of a human body such as blood vessels, nerves, and sweat glands of an epidermal tissue in a stable state where the treatment device captures subcutaneous tissues such that the treatment device grasps a skin surface of an affected part without sliding unlike pressing only the skin thus enhancing a chiropractic treatment effect.

That is, it is safe to say that the subcutaneous tissue therapy treatment device is a device having the following technical feature and functions. A contact area of a functional surface of the bifurcated treatment portion which is brought into contact with the skin is increased and, further, a roughened surface is formed so as to increase a friction resistance. With such a technical feature, a therapist can rotate or press the skin in a state where the skin is stretched at maximum so that stiffened tissues of an epicranial aponeurosis and a frontal muscle, an occipital muscle, temporal muscles between the skin and the cranial bone are pressed. Such a tissue pressed state is obtained by stretching the skin in a state where subcutaneous tissue cells cannot move away by grasping and stretching the scalp together with subcutaneous tissues, that is, by stretching the skin at maximum.

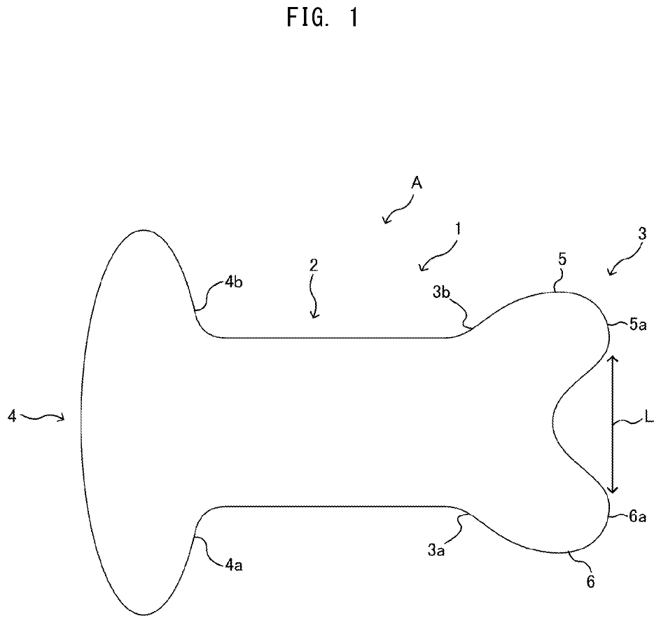

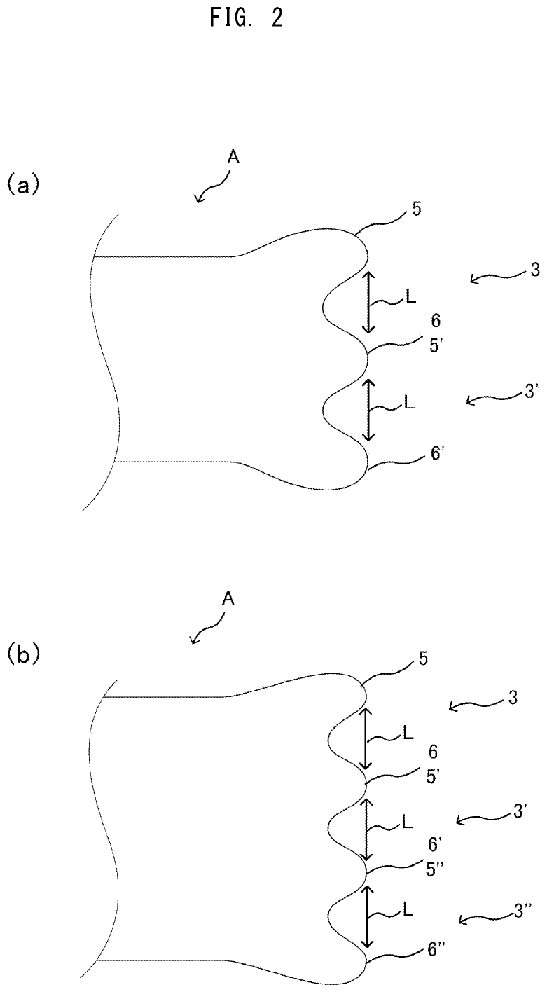

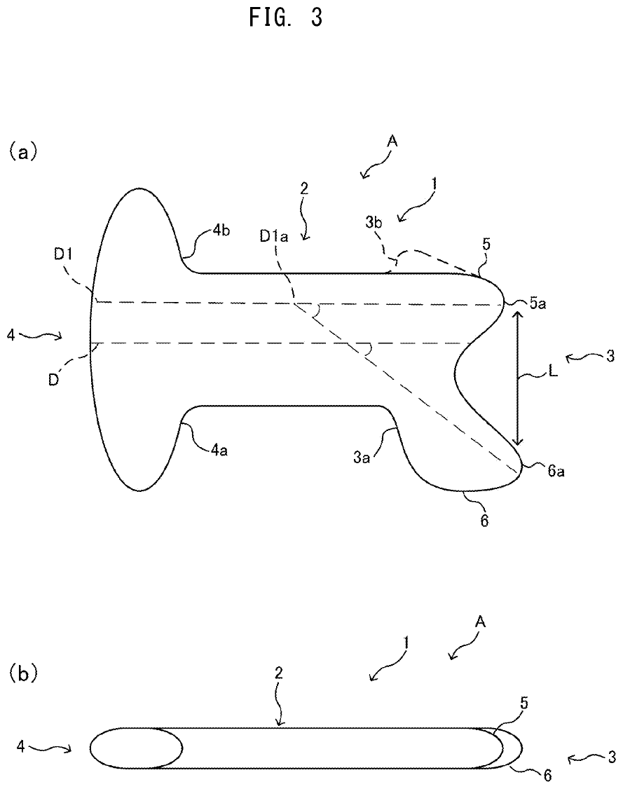

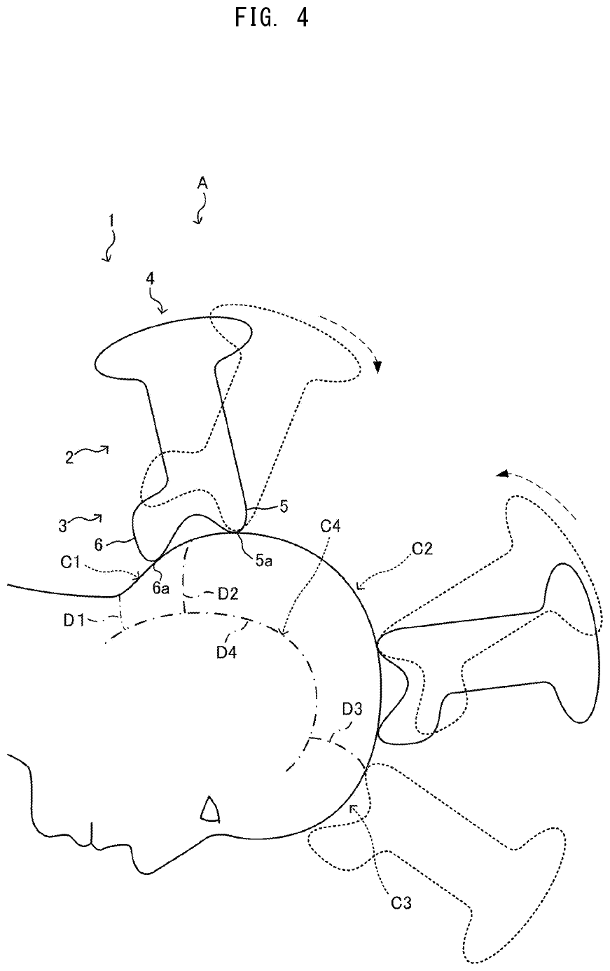

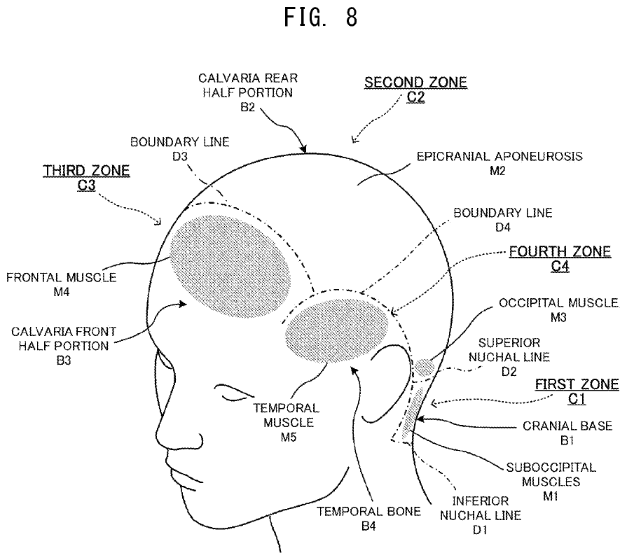

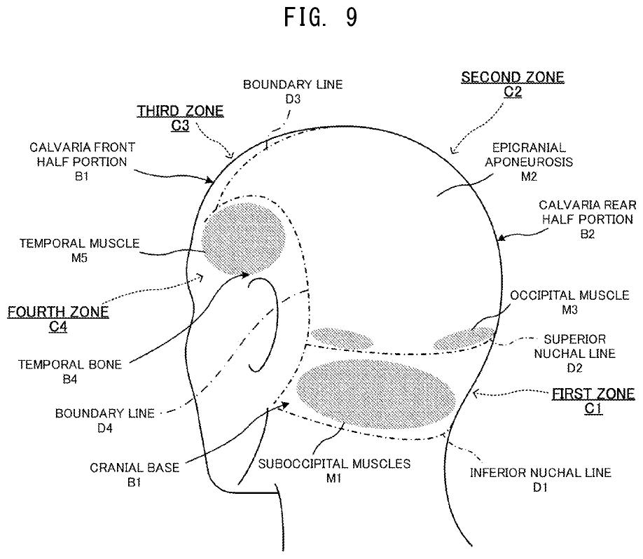

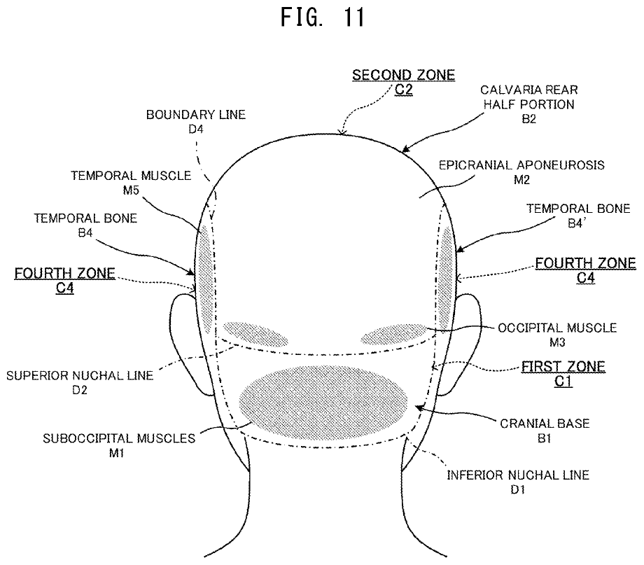

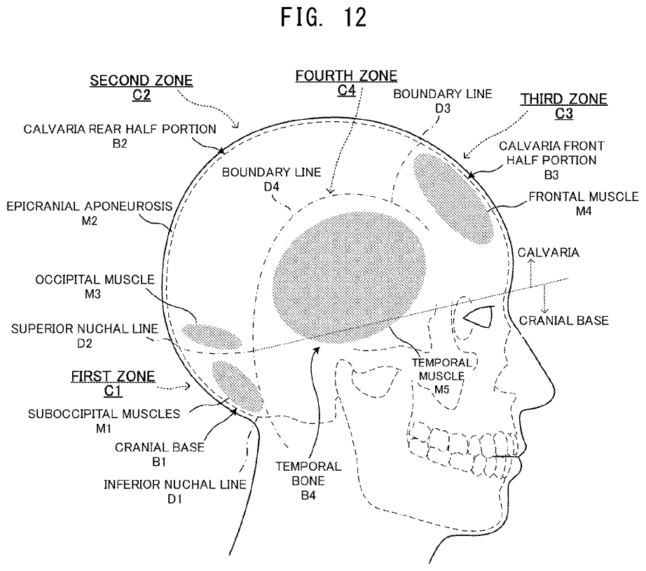

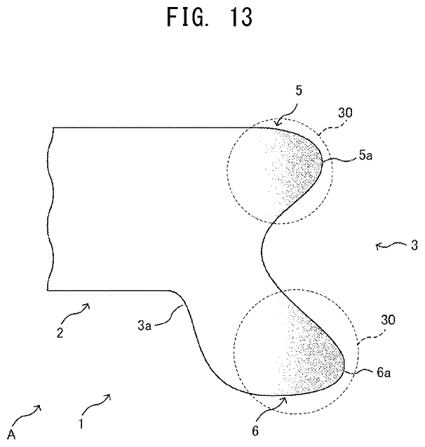

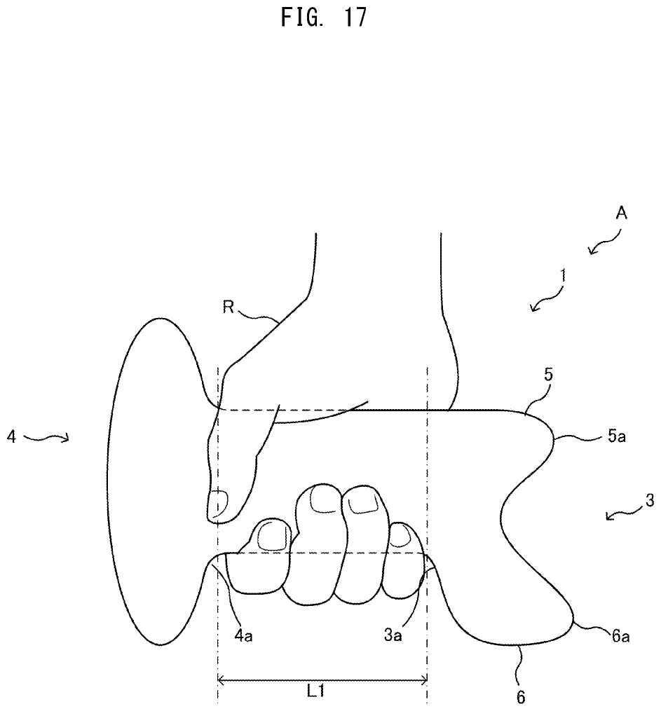

Hereinafter, a specific embodiment of this invention is described with reference to drawings. FIG. 1 and FIG. 2 are front views of the subcutaneous tissue therapy treatment device according to this embodiment, FIG. 3(a) and FIG. 3(b) are a front view and a plan view of the subcutaneous tissue therapy treatment device according to this embodiment, FIG. 4 to FIG. 7 and FIG. 20 to FIG. 22 are explanatory views showing in-use examples of the subcutaneous tissue therapy treatment device, FIG. 8 to FIG. 12 are explanatory views of a surface of a head where the surface is divided into zones which form treatment regions, FIG. 13 is a plan view showing front ends of an upper and lower protrusions of a bifurcated treatment portion in an enlarged manner, FIG. 14 to FIG. 16 are explanatory views showing modifications of the subcutaneous tissue therapy treatment device according to this embodiment, and FIG. 17 to FIG. 19 are explanatory views showing states where a therapist grips the subcutaneous tissue therapy treatment device with his palm.

### 1. Embodiment

As shown in FIG. 1 and FIG. 3, a treatment device body 1 of a subcutaneous tissue therapy treatment device A according to this invention is formed of: a grip portion 2 having a rod shape or a narrow-width flat-plate shape; and a bifurcated treatment portion 3 for a neck and a head formed on a distal end of the grip portion 2; and a grasp portion 4 formed on a rear end of the grip portion 2.

Further, in the treatment device body 1, the bifurcated treatment portion 3 for a neck and a head is formed of the combination of: a lower protrusion 6 positioned closer to the neck or a face portion during treatment; and an upper protrusion 5 positioned closer to a vertex region during treatment to each other. That is, the treatment device body 1 is formed in an approximately Y shape as shown in FIG. 1 and FIG. 3, a large wall thickness portion extending at a center portion of the Y shaped treatment device body 1 forms the grip portion 2, and a portion which extends from a distal end of the grip portion 2 in a bifurcated manner forms the bifurcated treatment portion 3.

As shown in FIG. 4 to FIG. 6, in a state where a surface of a cranial bone of a patient is divided into four zones consisting of a first zone C1, a second zone C2, a third zone C3, and a fourth zone C4 from an occipital region to a frontal region, the positions at which an upper protrusion front end 5a and a lower protrusion front end 6a of the bifurcated treatment portion 3 are brought into contact with the surface of the cranial bone are positions over which meridians which divide a surface of a cranial bone of a patient into four zones consisting of a first zone C1, a second zone C2, a third zone C3, and a fourth zone C4 and are distributed in a meshed shape in surface curved areas of the respective zones. That is, a distance between the upper protrusion front end 5a and the lower protrusion front end 6a of the bifurcated treatment portion 3 is a common distance which connects the meridians (acupuncture points) which exist in the respective zones.

The reason is as follows. As shown in FIG. 4 to FIG. 6, the bifurcated treatment portion 3 is basically formed so as to perform the treatment while applying a pressing stimulus to an affected part while tracing a spherical surface of the cranial bone. Accordingly, the bifurcated treatment portion structure is desired to exhibit a pressing force at maximum in such a manner that a direction along which a largest pressing stress is applied to the cranial bone becomes an incident direction perpendicular to the spherical surface as much as possible.

In general, the meridians which form treatment points exist in large number in areas in the vicinity of the neck or the face portion rather than in an area in the vicinity of the vertex region. That is, the meridians which form treatment points exist in large number in temporal muscles of temporal regions, frontal muscles of a frontal region, and a plurality of muscle groups of a suboccipital part which are large thickness tissues rather than in an epicranial aponeurosis having thin thickness tissues which cover substantially the entire region of the vertex region. Further, the surface of the head reaches the temporal regions, the frontal region, and the suboccipital part by way of a curved portion where the remoter a part of the curved portion is disposed from the vertex region, the larger a radius of curvature becomes.

That is, as shown in FIG. 8 to FIG. 12, in this invention, to allow a therapist to perform treatment suitable for a treatment point, the cranial bone is divided into four zones ranging from the occipital region to the frontal region. As the first zone C1 formed by dividing the surface of the cranial bone, a surface curved area which is a suboccipital muscles M1 portion which covers a cranial base B1 between left and right temporal bones B4, B4′ in layers and is positioned between an inferior nuchal line D1 and a superior nuchal line D2 of the nuchal lines is assumed. As the second zone C2 formed by dividing the surface of the cranial bone, a surface curved area which is formed of an occipital muscle M3 portion and an epicranial aponeurosis M2 portion which cover a calvaria rear half portion B2 between the left and right temporal bones B4, B4′, and is defined by an area formed between the superior nuchal line D2 of the nuchal lines and the frontal muscle M4 and an area formed between the left and right temporal bones B4, B4′ is assumed. As the third zone formed by dividing the surface of the cranial bone, a surface curved area defined by a frontal muscle M4 portion which covers a calvaria front half portion B3 between the left and right temporal bones B4, B4′ is assumed. As the fourth zone C4 formed by dividing the surface of the cranial bone, surface curved areas defined by temporal muscles M5, M5′ which cover the left and right temporal bones B4, B4′ are assumed.

As the shape which conforms to such a logic, in this embodiment particularly, as shown in FIG. 1 and FIG. 3, the bifurcated treatment portion 3 for a neck and a head is formed by combining the lower protrusion 6 positioned closer to the neck or the like during treatment and the upper protrusion 5 positioned closer to the vertex region during treatment.

The bifurcated treatment portion 3 is formed such that a distance L between the upper protrusion front end 5a and the lower protrusion front end 6a becomes a common distance at which meridians (acupuncture points) existing in the respective zones are connected to each other.

To be more specific, the distance L between the front end 5a of the upper protrusion 5 and the front end 6a of the lower protrusion of the bifurcated treatment portion 3 is basically set in accordance with measurement used in the oriental medicine.

For example, the distance L can be set in accordance with a distance between meridians in general which exists for respective physical characteristics of patients such as a size and a shape of a head of the patient. Here, patients are, for example, a child, an adult, a woman, or a man. In this embodiment, a length of the distance L between the front end 5a of the upper protrusion and the front end 6a of the lower protrusion of the bifurcated treatment portion 3 is set to approximately 4 to 7 cm, preferably, 5 to 6 cm.

In this embodiment, the bifurcated treatment portion 3 of the subcutaneous tissue therapy treatment device A includes not only a bifurcated portion on a simple two-pronged treatment portion formed on the treatment device body 1, but also a bifurcated portion included in a plural-pronged treatment portion such as a three-pronged treatment portion, a four-pronged treatment portion, or a five-pronged treatment portion which is pronged in a vertical direction at the distal end of the grip portion 2 formed on the treatment device body 1, and such a bifurcated portion has a distance which is set in accordance with respective zones.

That is, it is sufficient that the bifurcated treatment portion 3 of this invention be included in the plural-pronged treatment portion of the treatment device body 1 as shown in FIG. 2. FIG. 2(a) shows a mode where two bifurcated treatment portions 3, 3′ are included in the three-pronged treatment portion, and FIG. 2(b) shows a mode where three bifurcated treatment portions 3, 3′, 3″ are included in the three-pronged treatment portion.

To be more specific, as shown in FIG. 2(a) and FIG. 2(b), in the case where the plurality of protrusions are formed continuously in the vertical direction on the distal end of the grip portion 2 as viewed in a front view, with respect to two protrusions disposed adjacently to each other vertically among the plurality of protrusions, assuming that a distance between the front ends is the common distance L at which meridians (acupuncture points) respectively existing in the respective zones are connected to each other, these two protrusions 5, 6, the protrusions 5′ 6′, and the protrusions 5″, 6″ are respectively the upper and lower protrusions 5, 6 of the present invention, and form the bifurcated treatment portion 3.

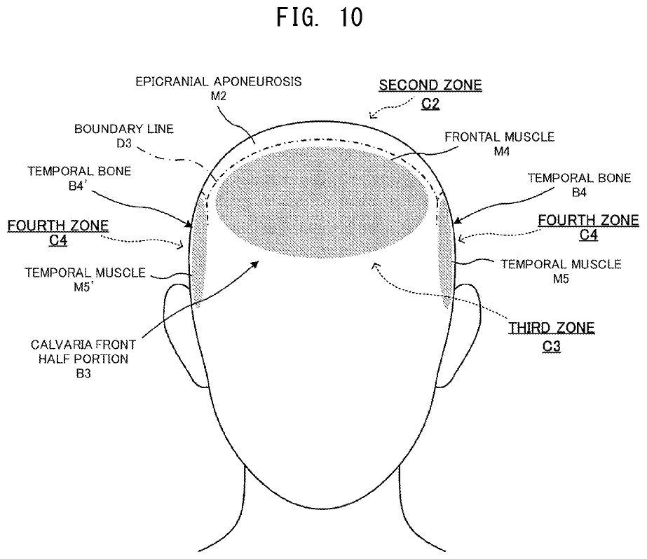

A roughened surface 30 which increases a friction resistance is formed on a functional surface of the bifurcated treatment portion 3 formed on the front end of the grip portion 2 as shown in FIG. 10.

As a method for forming such a roughened surface 30, for example, a fine uneven surface is formed on a surface of the treatment device body 1 by applying sand blasting or granular particles coating treatment to the surface of the treatment device body 1, or by forming the treatment device body 1 itself by 3D printer lamination molding or granular particles dispersion and curing molding.

In applying sand blasting to the surface of the treatment device body 1, a fine uneven surface, for example, an uneven surface having roughness of meshes of a file is formed by grinding the surface of the treatment device body 1 using a grindstone, a sandpaper, or a file.

In applying granular particles coating treatment to the surface of the treatment device body 1, a fine uneven surface is formed by spraying and adhering fine granular particles such as glass powder or sand particles to the surface of the treatment device body 1.

In forming the treatment device body 1 by 3D printer lamination molding, for example, fine unevenness is formed along a vertical direction on front end surfaces of the upper and lower protrusions 5, 6 by laminating a resin or the like in a direction orthogonal to an axis of the grip portion, to be more specific, in a direction orthogonal to an imaginary plane formed of a front end surface of the upper protrusion 5 and a front end surface of the lower protrusion 6.

In forming the treatment device body 1 by granular particles dispersion and curing molding, a resin in an uncured state in which fine granular particles are dispersed is poured into a mold for forming the treatment device body 1 and is cured so that a fine uneven surface is formed such that the granular particles are exposed on an outer surface of the treatment device body 1. A particle size of granular particles used in granular particles coating treatment and the granular particles dispersion and curing molding is not particularly limited provided that the roughened surface 30 is formed on the surface of the treatment device body 1.

By setting surface roughness Ra of the roughened surface 30 which is the functional surface of the bifurcated treatment portion 3 formed by the above-mentioned method to 10 μm to 35 μm, more preferably, 15 μm to 30 μm, the bifurcated treatment portion 3 can acquire a friction resistance force against a surface of a scalp with certainty.

The functional surface of the bifurcated treatment portion 3 is not particularly limited provided that the functional surface has a large friction resistance. For example, the functional surface of the bifurcated treatment portion 3 may be obtained by exteriorly mounting an elastic material (for example, vinyl resin) which is formed as a separate part or a cap shaped part having a roughened surface to the surfaces of the upper and lower protrusions 5, 6 of the bifurcated treatment portion 3. That is, the functional surface of the bifurcated treatment portion 3 may be formed of a cap shaped part which is detachably mounted on the upper and lower protrusions 5, 6 and has a large friction resistance.

In the above-mentioned configuration, the functional surface of the bifurcated treatment portion 3 are surfaces where the front end surface of the upper protrusion 5 and the front end surface of the lower protrusion 6 are brought into contact with the surface of the scalp respectively. A surface area of the front end surface of each of the upper protrusion 5 and the lower protrusion 6 is set to 5 mm² to 30 mm², more preferably, 10 mm² to 25 mm².

With such a configuration, when the bifurcated treatment portion 3 is placed on the surface of the scalp, the front end surfaces of the upper and lower protrusions 5, 6 are brought into face contact with the surface of the scalp so that a friction resistance surface can be increased, a damage on the surface of the scalp by the front ends of the upper and lower protrusions 5, 6 can be prevented, and sliding of the treatment device body 1 on the surface of the scalp can be prevented. Further, when the treatment device body 1 is pressed and rotated in a state where the bifurcated treatment portion 3 grasps the surface of the scalp together with subcutaneous tissues of a deep portion of the scalp over a wide range, it is possible to alleviate stiffness of affected tissues with certainty.

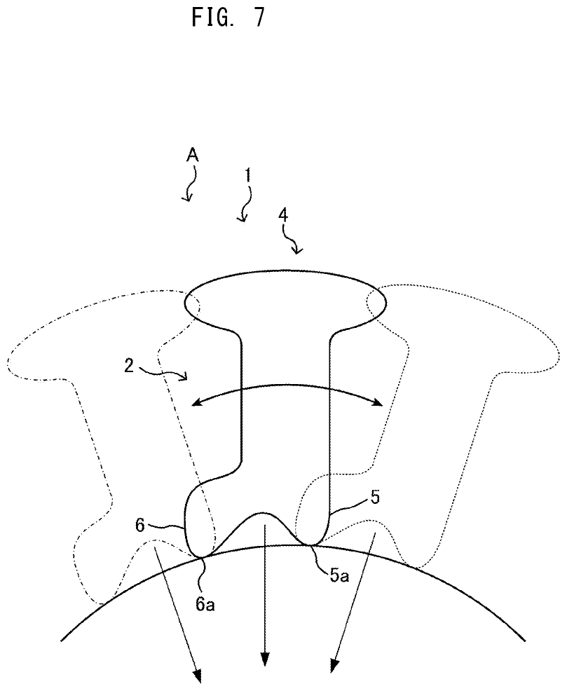

As shown in FIG. 3, the lower protrusion 6 of the bifurcated treatment portion 3 is formed in a shape that the lower protrusion 6 protrudes more than the upper protrusion 5 in a distal end direction. That is, in pressing the rod-shaped grip portion 2 in a direction perpendicular to the surface of the cranial bone, since the upper and lower protrusions 5, 6 differ from each other with respect to a length to the front end as shown in FIG. 7, the bifurcated treatment portion 3 can apply a stimulus as uniformly as possible to subcutaneous cells at different positions on the surface of the spherical cranial bone with the same pressing stress generated by both protrusions.

That is, as shown in FIG. 4 to FIG. 7, the surface of the cranial bone which is divided into four zones has a spherical surface in all zones. Accordingly, to conform to unevenness brought about by a curved surface of the cranial bone, with respect to affected parts at two places spaced apart from each other at a fixed distance in each zone, the lower affected part (rear affected part) has a larger distance than the upper affected part (front affected part) as viewed from the grip portion 2 with respect to a pressing direction of the grip portion 2 extending perpendicular to the surface of the cranial bone.

Accordingly, with respect to the lengths of the upper and lower protrusions 5, 6, by setting the length of the lower protrusion 6 larger than the length of the upper protrusion 5 as described above, it is possible to uniformly apply a treatment pressing force to the affected part at two positions disposed on upper and lower edge portions of the zone.

Particularly, in pressing the suboccipital muscles M1 portion disposed in the surface curved area of the first zone C1, the frontal muscle M4 portion disposed in the surface curved area of the third zone C3, and the temporal muscle M5 portion disposed in the surface curved area of the fourth zone C4 where meridians (acupuncture points) which form treatment points are densely distributed, the front end 5a of the upper protrusion 5 of the bifurcated treatment portion 3 is disposed at the epicranial aponeurosis M2 portion disposed in the surface curved areas of the second zone C2 as a fulcrum of a lever, and a pressing force is applied to respective affected parts of the suboccipital muscles M1, the frontal muscle M4, and the temporal muscle M5 using the front end 6a of the lower protrusion 6 as a point of action. Accordingly, the bifurcated treatment portion 3 can apply pressing stimulus to meridians distributed in the surface curved areas of the respective zones with certainty.

The relationship between the lengths (distances to the front ends of the respective protrusions using a bifurcated valley portion as a proximal end in an axial direction of the grip portion) of the upper and lower protrusions 5, 6 differs depending on a bifurcated opening angle (inclination angle) made by the upper and lower protrusions 5, 6. As one example, the relationship is set such that length of upper protrusion:length of lower protrusion=1:1 to 1.5.

In the subcutaneous tissue therapy treatment device A according to this invention, as shown in FIG. 3, in the treatment device body 1, the upper protrusion 5 of the bifurcated treatment portion 3 is made to protrude along a direction of an axis E of the grip portion 2 (indicated by a broken line in FIG. 3), and the lower protrusion 6 is disposed in an inclined manner with respect to the direction of the axis E of the grip portion 2 at an inclination angle of approximately 40° to 60°.

To be more specific, in the treatment device body 1, the upper protrusion 5 is formed such that one end of an upper protrusion axis E1 spaced apart from the axis E by a predetermined distance and extending parallel to the axis C of the grip portion 2 forms the front end 5a of the upper protrusion 5.

On the other hand, in the treatment device body 1, the lower protrusion 6 is formed such that a distal end of a lower protrusion axis E2 having the same distal end direction as the front end 5a of the upper protrusion 5 and extending in an inclined manner from an approximately center portion E1a of the upper protrusion axis E1 at an inclination angle of approximately 40° to 60° forms the front end 6a of the lower protrusion 6.

With such a configuration, as shown in FIG. 4 to FIG. 7, a pressing stress generated at the time of pressing the rod-shaped grip portion 2 in the direction perpendicular to the surface of the cranial bone is divided into substantially same pressing component forces from a middle portion of the axis E of the grip portion 2 and an approximately center portion E1a of the upper protrusion axis E1 to the respective front ends 5a, 6a of the upper and lower protrusions 5, 6.

That is, the lower protrusion 6 is formed with an inclination of approximately 40° to 60° from the approximately center portion E1a with respect to the upper protrusion axis E1 which is the direction of a pressing stress of the upper protrusion 5 corresponding to a spherical surface of the cranial bone. Accordingly, the pressing stress on the upper protrusion axis E1 is divided in two directions from the approximately center portion E1a and forms the approximately uniform pressing component forces.

As a result, with respect to the subcutaneous tissue therapy treatment device A, in pressing the rod-shaped grip portion 2 in the direction perpendicular to the surface of the cranial bone, a pressing component force can be applied in the direction perpendicular to the surface of the cranial bone by the upper protrusion 5. On the other hand, a pressing component force substantially equal to the pressing component force of the upper protrusion 5 can be applied in an inclined direction with respect to the spherical surface of the cranial bone by the lower protrusion 6. Accordingly, a more uniform treatment pressing force is applied to affected parts at two places disposed on upper and lower edge portions of the zone.

Further, the distance between the front ends of the upper and lower protrusions 5, 6 is set so as to be used in four zones in common. That is, the distance between the front ends of the upper and lower protrusions 5, 6 satisfies: a distance where the distance strides over a boundary line (superior nuchal line D2) between the first zone C1 and the second zone C2, the longer lower protrusion 6 is brought into contact with the meridian in the first zone C1 and the shorter upper protrusion 5 is brought into contact with the meridian in the second zone C2; a distance where the upper and lower protrusions 5,6 are brought into contact with the front and rear meridians scattered in the respective longitudinal directions in an area of the second zone; a distance where the longer lower protrusion is brought into contact with the meridian in the third zone while displacing the shorter upper protrusion along a boundary line D3 between the second zone and the third zone; a distance where the longer lower protrusion is brought into contact with the meridian in the fourth zone while displacing the shorter upper protrusion along a boundary line D4 between the second zone and the fourth zone and the like.

In this embodiment, names of respective parts such as cranial bone, muscles which cover the cranial bone and the like indicate places of such parts as shown in FIG. 8 to FIG. 11. Particularly, the names or the terms of the respective parts used in this specification are defined as follows.
cranial bone: a bone which protects a brain from the outside by supporting the face structure, and is formed by seaming twenty-two bones
calvaria: a bone which is a part of the cranial bone and forms an upper half round portion of the head
cranial base: a bone which is a part of the cranial bone and forms a lower half portion of the head
nuchal lines: a region having a superior nuchal line and an inferior nuchal line on upper and lower portions of the region respectively
superior nuchal line: a traverse line which exists on a raised portion of the occipital bone and runs toward a mastoid process on a boundary between an occipital plane of a calvaria and a nuchal plane of the cranial base
inferior nuchal line: a traverse line which exists below the superior nuchal line and runs toward the mastoid process
temporal bones: bones which form left and right side portions of the cranial bone
parietal bone: a bone which forms a part of the cranial bone and extending from a top (vertex) of the head to a just rear side of the head
frontal bone: a bone which forms a front portion of the cranial bone exists between the left and right temporal bones
occipital bon: a bone which forms a rear portion of the cranial bone and exists between the left and right temporal bones
temporal muscles: muscles which substantially cover the entire region of the left and right temporal bones
epicranial aponeurosis: thin fibrous tissues which covers the cranial bone toward the respective muscles
frontal muscles: muscles which are formed by extending the epicranial aponeurosis frontward and covers the front portion of the cranial bone
occipital muscles: muscles disposed above the superior nuchal line and covers a portion of the occipital bone
suboccipital part muscles: a group of muscles formed of a plurality of muscles which are disposed below the superior nuchal line and adhere to the cranial base

Meridians are lines which run in a meshed shape such that each meridian connects an acupuncture point and an acupuncture point distributed in a spotted manner. The meridians are distributed over the entire region of the head, and particularly concentrated on the frontal muscles, the occipital muscles, and temporal muscles.

Although the positions of the meridians existing in the respective zones differ depending on the size and the shape of a head of a patient, in general, a therapist places his fingers on the head of the patient, and decides the positions of meridians by measurement based on a width between the fingers.

To be more specific, the positions of the meridians distributed in each zone are decided using distances from the reference position existing on the head to the meridians such as a width of fingers, for example, a width of a thumb (one length in oriental medicine), a width from an index finger to a ring finger (two lengths in oriental medicine), a width from the index finger to a little finger (three lengths in oriental medicine) as scales of distances from the reference position to the meridians.

A material for forming the treatment device body 1 is not particularly limited. For example, metal, a resin, or wood can be adopted as such a material.

When a resin is adopted as the material for forming the treatment device body 1, by forming the treatment device body 1 using a hard resin (for example, a nylon resin) and by forming a surface of the treatment device body 1 using a soft resin having elasticity (for example, a vinyl resin) by coating, the occurrence of a case where a surface of a scalp is inadvertently damaged during treatment can be prevented as much as possible.

In this embodiment, the treatment device body 1 is formed using a nylon resin so that the treatment device as a whole has a considerable weight. Accordingly, a therapist can easily perform a treatment operation by making use of its own weight of the treatment device body 1 together with gripping of the treatment device.

The treatment device body 1 is formed such that the grip portion 2 has a large wall thickness, and a thickness of the bifurcated treatment portion 3 is gradually decreased from a proximal end to a distal end. As a result, the treatment device can hold a considerable weight and thickness as a whole. To be more specific, the thickness of the grip portion is set to approximately 1.5 cm to 3.5 cm, and the thickness of the bifurcated treatment portion 3 is set to approximately 0.3 cm to 3.5 cm such that the thickness of the bifurcated treatment portion 3 is gradually decreased from the proximal end to the distal end.

By forming the above-mentioned roughened surface 30 on the entire outer surface of the treatment device body 1, a friction resistance when a therapist grips the grip portion 2 or the grasp portion 4 with his palm is increased and hence, it is possible to prevent the occurrence of a case where his palm is inadvertently slid and displaced from the grip portion 2 or the grasp portion 4 due to sweating, drying or the like of his palm.

In other words, uneven working for forming a roughened surface is applied to the entire outer surface of the treatment device body 1 and hence, the subcutaneous tissue therapy treatment device A can realize a treatment as if a skin or a scalp which is brought into contact with the treatment device body 1 is grasped by concaves and convexes of such a roughened surface.

As shown in FIG. 17, a length of a rod-shaped or a narrow-width plate shaped grip portion 2 formed between the bifurcated treatment portion 3 and the grasp portion 4 is set to a length L1 substantially equal to a width of a palm gripping part of a therapist R. Accordingly, when the therapist R rounds his palm gripping part and grips the grip portion 2, both end surfaces of his palm gripping part in a width direction are brought into close contact with a proximal portion 3a of the bifurcated treatment portion 3 and a proximal portion 4a of the grasp portion 4.

As shown in FIG. 3(a), not only the proximal portion 3a is formed on a lower protrusion 6 side of the bifurcated treatment portion 3 but also a proximal portion 3b may be formed on an upper protrusion 5 side by forming the upper protrusion 5 such that the upper protrusion 5 expands toward the outside. In this case, due to the provision of the upper and lower proximal portions 3a, 3b, when a therapist grips the rod-shaped grip portion 2, a width of his rounded palm gripping part and a width of his palm fall within the respective proximal portions in a state where the palm gripping part is brought into close contact with the upper and lower proximal portions 3a, 3b of the bifurcated treatment portion 3 and the upper and lower proximal portion 4a, 4b of the grasp portion 4 so that the palm gripping part can acquire a gripping stress with more certainty.

As another modification, as shown in FIG. 14(c) which is a cross-sectional view, the rod-shaped grip portion 2 may be formed in an approximately flat shape and may be also formed in a thick wall portion shape where a wall thickness of the grip portion 2 (indicated by A-A cross section in the drawing) is increased compared to a wall thickness of the bifurcated treatment portion 3 and a wall thickness of the grasp portion 4.

Further, as shown in FIG. 14(a) and FIG. 14(b), the bifurcated treatment portion 3 is gradually sharpened toward the front ends, and most front end portions are formed in a round shape as viewed in a plan view and in a shape where wall thickness is gradually decreased toward the front ends as viewed in a side view. With such a configuration, the bifurcated treatment portion 3 can be properly and fixedly placed on treatment effective points of an affected part, and the bifurcated treatment portion 3 can effectively apply its function to subcutaneous tissues of the affected part without applying an undesired excessive stimulus to the affected part.

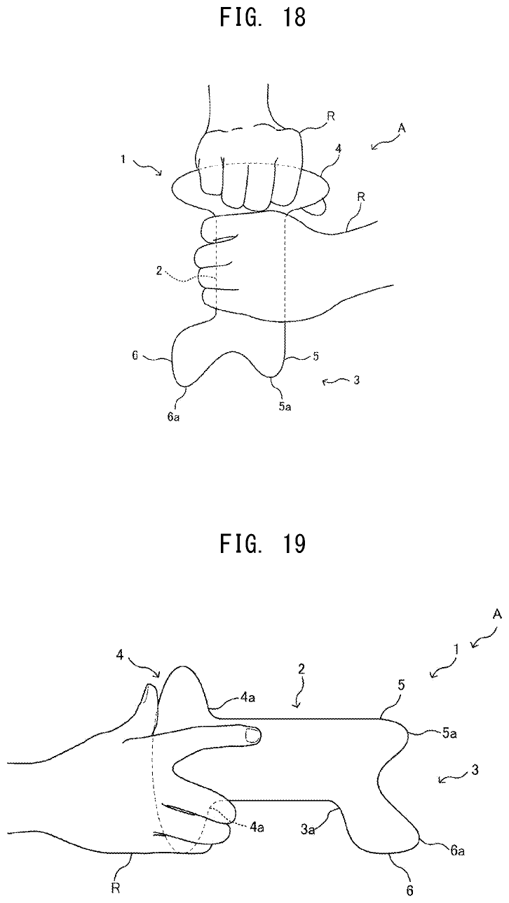

As shown in FIG. 3, the grasp portion 4 is formed in an approximately T shape as viewed in a plan view. During treatment, a lateral side portion of the T shaped grasp portion 4 is brought into contact with a palm of a therapist, and a longitudinal side portion of the T shaped grasp portion 4 is sandwiched between fingers of the therapist R. In pressing an affected part by the bifurcated treatment portion 3, as shown in FIG. 18 and FIG. 19, the bifurcated treatment portion 3 is supported by gripping the grasp portion 4 between the palm of the therapist and the fingers of the therapist R.

The lateral side portion of the T shaped grasp portion 4 may be formed in a curved shape so as to allow the grasp portion 4 to apply a pressing stimulus to subcutaneous tissues (meridians) of a proximal portion of a neck. With such a configuration, by gripping the grip portion 2 in a reversed manner in a longitudinal direction so as to position the grasp portion 4 in a distal end direction of the grip portion 2, it is possible to expand a scope of effective utilization of the treatment device body 1 by making use of the treatment device body 1 in treatment of subcutaneous tissues of an affected part in the vicinity of a rear of patient's neck instead of an occipital region.

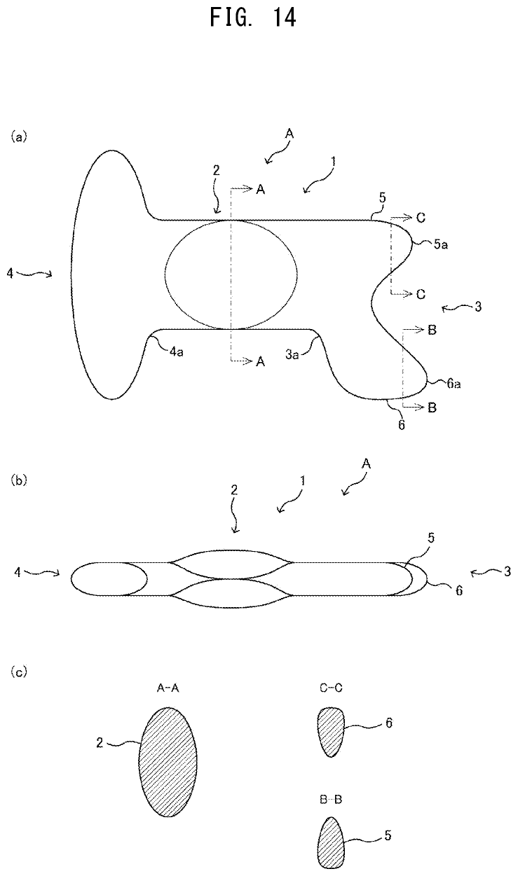

As another embodiment, as shown in FIG. 15, upper and lower protrusions 5, 6 of a bifurcated treatment portion 3 may be formed in a flat shape, and a center portion of a flat distal end edge in a wall thickness direction may be formed in a recessed shape thus forming both left and right side protruding edge portions 5b, 5c, 6b, 6c on both flat side surfaces.

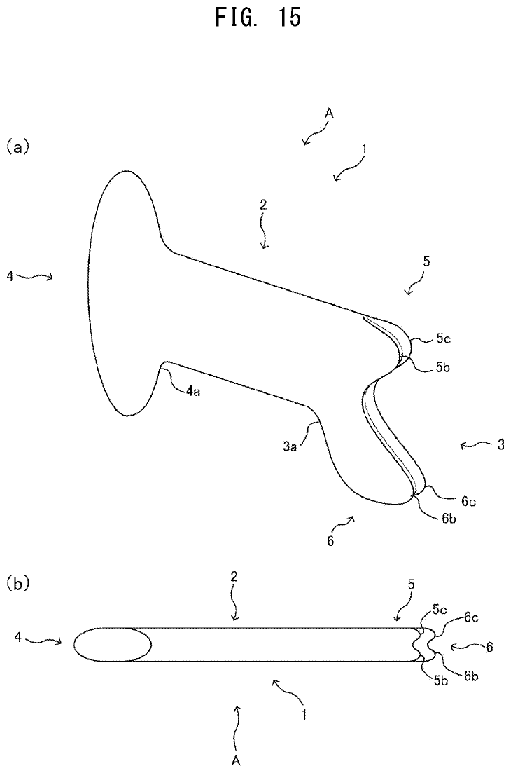

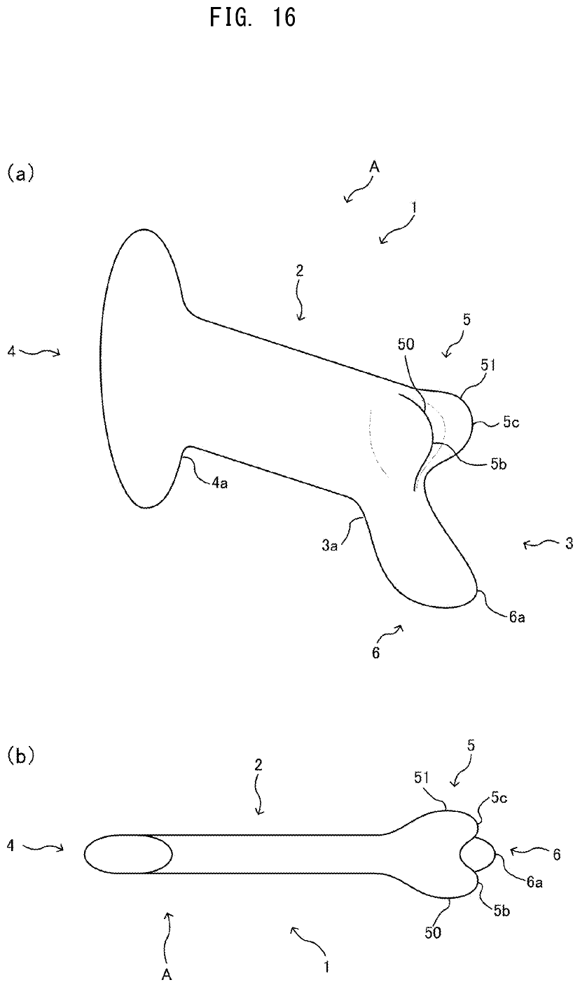

As still another embodiment, as shown in FIG. 16, in upper and lower protrusions 5, 6 of the bifurcated treatment portion 3, the upper protrusion 5 is bifurcated in an expanded manner protruding outward laterally from a flat large wall thickness portion so as to form two upper protrusions 50, 51. That is, the subcutaneous tissue therapy treatment device A may be formed in a three legged structure formed of the above-mentioned two upper protrusions 50, 51 and one lower protrusion 6.

Two left and right upper protrusions 50, 61 are formed in a protruding manner and in a bifurcated manner toward the outside in a lateral thickness direction from the flat large wall thickness portion of the treatment device body 1 such that the respective front ends 5b, 5c are disposed on left and right sides from the center position which is the position of the front end 6a of the lower protrusion 6 in a thickness direction of the treatment device body 1.

### 2. Clinical Example in which Subcutaneous Tissue Therapy Treatment Device is Used

Next, a clinical example where the subcutaneous tissue therapy treatment device A of this invention is applied to a head of a patient is specifically described.

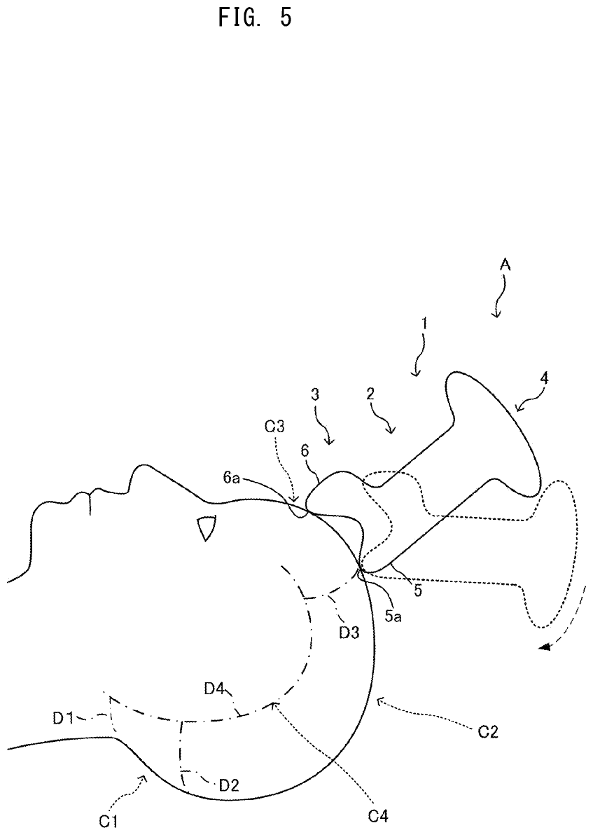

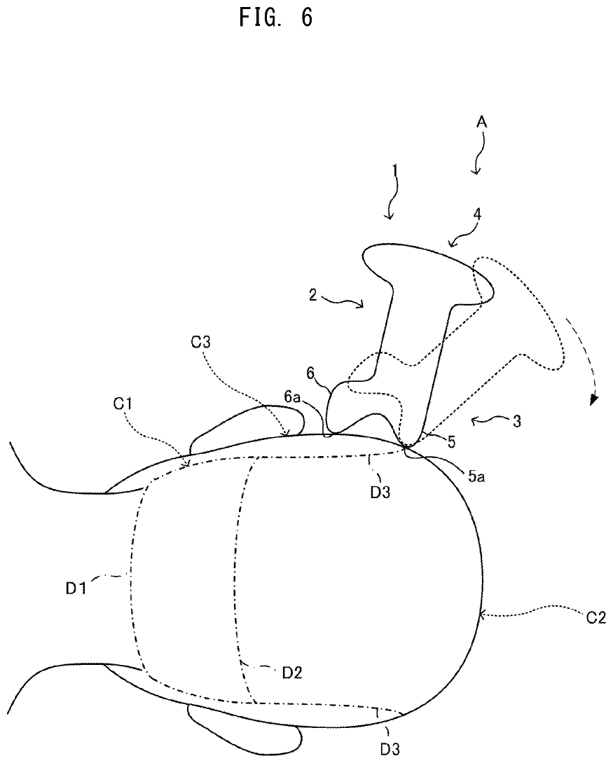

As shown in FIG. 4 to FIG. 6 and FIG. 22, the patient lies on a bed in postures corresponding to treatments applied to the respective zones. That is, in applying treatment to the first zone C1 and the second zone C2, the patient lies on the bed in a face-down state with his occipital region directed upward as shown in FIG. 4. In applying treatment to the third zone C3, the patient lies on the bed in a face-up state with his frontal region directed upward as shown in FIG. 5. In applying treatment to the fourth zone C4, the patient lies on the bed sideways with his temporal region directed upward as shown in FIG. 6.

In such states, treatment is applied to four zones using the subcutaneous tissue therapy treatment device A of this invention by applying a pressing stimulus to a surface of a cranial bone in a direction indicated by an arrow in FIG. 7, that is, in a direction perpendicular to the surface of the cranial bone.

Firstly, as shown in FIG. 17, a therapist grips the grip portion 2 of the treatment device body 1 with his palm gripping part and brings the bifurcated treatment portion 3 into contact with a head at a predetermined position. Particularly, the upper protrusion 5 of the bifurcated treatment portion 3 is positioned at an upper position closer to a vertex region, and the lower protrusion 6 of the bifurcated treatment portion 3 is positioned at a lower position closer to a neck or the like.

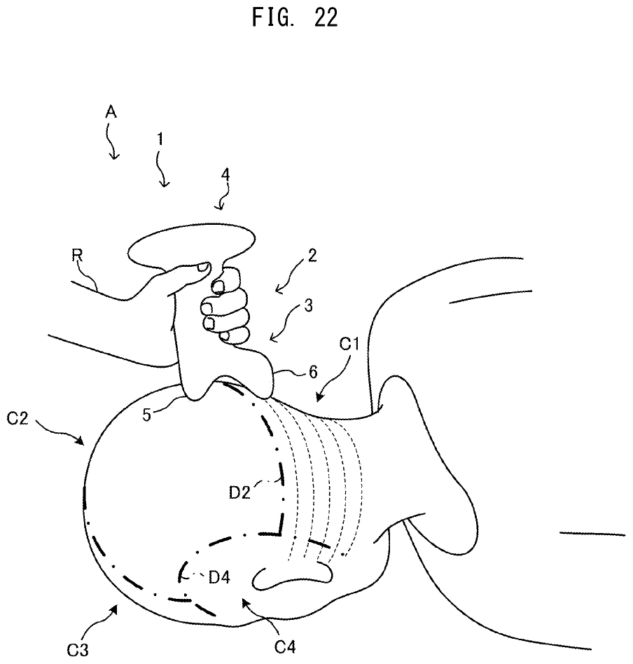

In the first zone, pressing is applied to the suboccipital muscles M1 portion which covers the cranial base B1 between the left and right temporal bones B4, B4′ in layers in the surface curved area positioned between the inferior nuchal line D1 and the superior nuchal line D2 of the nuchal lines. That is, as shown in FIG. 4 and FIG. 22, in the therapy in the first zone 1, a stimulus therapy is performed by setting a distance which strides over the boundary line between the first zone C1 and the second zone C2 in a state where the longer lower protrusion 6 is brought into contact with the meridians in the first zone C1 and the shorter upper protrusion 5 is brought into contact with the meridians in the second zone C2 as the distance between the front ends (distance between the distal ends) of the bifurcated treatment portion 3.

To be more specific, pressing treatment is applied to the meridians which are distributed in the respective areas in a state where the bifurcated treatment portion 3 strides over the superior nuchal line D2 which is the boundary line between the first zone C1 and the second zone C2, and the front end 5a of the upper protrusion 5 of the bifurcated treatment portion 3 is brought into contact with meridians distributed in a rear portion of the epicranial aponeurosis M2 or in the occipital muscles M3 in the second zone and the front end 6a of the lower protrusion 6 is brought into contact with the meridians distributed in the suboccipital muscles M1 in the first zone C1.

In positioning the treatment places, as shown in FIG. 4, firstly, the subcutaneous tissue therapy treatment device A is moved upward (an arrow direction indicated by a broken line in FIG. 4) in a state where the front end 5a of the upper protrusion 5 of the bifurcated treatment portion 3 is pressed to the meridians of the rear portion of the epicranial aponeurosis M2 or the occipital muscles M3 in the second zone thus applying a tension to the suboccipital muscles M1 by way of the epicranial aponeurosis M2 or the occipital muscle M3.

Next, by pressing the lower protrusion 6 to the suboccipital muscles M1 in a tensioned state in the first zone C1, the meridians distributed in the respective zones can be captured by grasping the meridians distributed in the respective zones by the bifurcated treatment portion 3.

Further, in such a state, the subcutaneous tissue therapy treatment device A is used in a state where an advancing direction of a pressing stress of the grip portion 2 is directed in a direction perpendicular to a head cranial bone of a patient lying on the bed with his face down.

Particularly, in the therapy in the first zone, the bifurcated treatment portion 3 is made to traverse the occipital region while performing lateral movement little by little in the lateral direction along the surface curved areas of the suboccipital muscles M1 in the first zone C1 and a rear portion of the epicranial aponeurosis M2 or the occipital muscles M3 in the second zone.

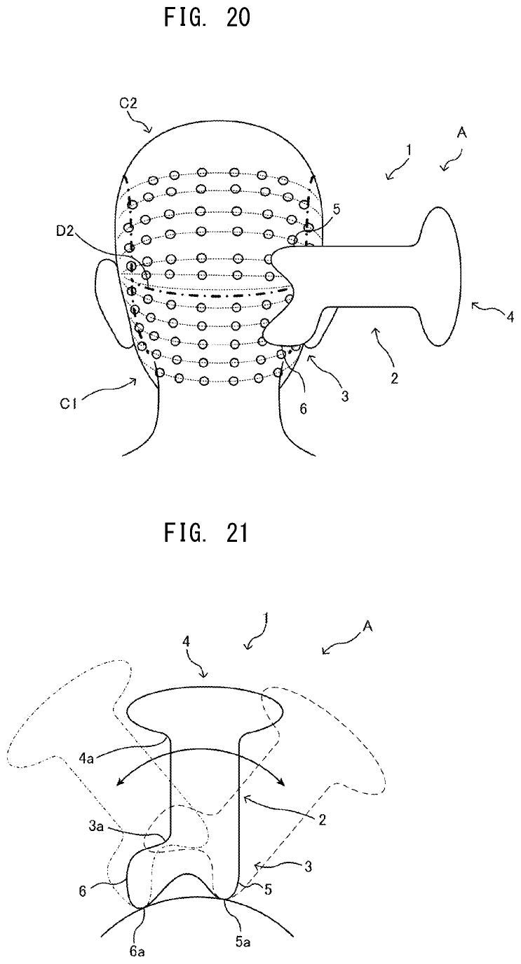

In performing lateral movement, as shown in FIG. 20, stimulus treatment is performed by pressing subcutaneous fat tissues at fourteen meridian points in total consisting of seven meridian points (acupuncture points on the meridian) in the left side and seven meridian points in the right side in the first zone C1 and the second zone C2 respectively.

Further, at respective points in the first zone C1 and the second zone C2, the upper protrusion 5 of the bifurcated treatment portion 3 applies a pressing stress to a rear portion of the epicranial aponeurosis M2 in the second zone C2 or the occipital muscle M3 in the second zone C2, and the lower protrusion 6 of the bifurcated treatment portion 3 applies a pressing stress to the suboccipital muscles M1 in the first zone C1. Such applying of a pressing stress is performed alternately or simultaneously.

That is, firstly, in applying a pressing stimulus to the rear portion of the epicranial aponeurosis M2 or the occipital muscle M3 in the second zone C2 by the upper protrusion 5 of the bifurcated treatment portion 3 or to the suboccipital muscles M1 in the first zone C1 by the lower protrusion 5 of the bifurcated treatment portion 3 respectively, as shown in FIG. 21, a pressing stimulus is applied to an affected part using the grip portion 2 as a point of effort of a lever, the front end 5a of the shorter upper protrusion 5 as a fulcrum of the lever, and the front end 6a of the longer lower protrusion 6 as a point of action of the lever.

Next, as an opposite case, by applying a pressing stimulus to an affected part using the front end 6a of the longer lower protrusion 6 as a fulcrum and the front end 5a of the upper protrusion 5 as a point of action, the treatment is performed while changing a pressing stimulus applying point such that the respective upper and lower protrusions 5, 6 form a pressing fulcrum and a pressing point of action alternately.

That is, at the respective points on the rear portion of the epicranial aponeurosis M2 or the occipital muscle M3 in the second zone C2 and the suboccipital muscles M1 in the first zone C1, a pressing force generated by the upper protrusion 5 is applied in a direction perpendicular to the epicranial aponeurosis M2 or the occipital muscle M3 on an outer side surface of the calvaria rear half portion B2, and a pressing force generated by the lower protrusion 6 is applied in a direction perpendicular to the suboccipital muscles M1 on an outer bottom surface of the cranial base B1.

As a result, the upper protrusion 5 applies a pressing stimulus to meridians distributed in a rear portion of the epicranial aponeurosis M2 or the occipital muscle M3 in the second zone C2 in a direction perpendicular to a calvaria side surface, and the lower protrusion 6 applies a pressing stimulus to meridians distributed in the suboccipital muscles M1 in the first zone C1 such that an outer bottom surface of the cranial base B1 is pushed up. Such applying of a pressing stimulus is performed along a traverse direction of the head sequentially.

In this manner, by making lengths of the upper and lower protrusions 5, 6 differ from each other and by alternately displacing a fulcrum and a point of action between the respective upper and lower protrusions 5, 6 during treatment, a switching operation between a fulcrum and a point of action can be performed with a small amount of alternating pressing operations to a surface of the cranial bone having an approximately spherical surface.

Particularly, by applying the bifurcated treatment portion 3 to an affected part using the upper protrusion 5 as a fulcrum and the lower protrusion 6 as a point of action, it is possible to apply a pressing force generated by the bifurcated treatment portion 3 to a deep portion of the suboccipital muscles M1 where a plurality of muscles overlap with each other in layers, that is, to muscles disposed at a lower layer position.

Next, in the second zone C2, pressing of a surface curved area is performed, wherein the surface curved area is at the occipital muscle M3 portion and the epicranial aponeurosis M2 portion which cover the calvaria rear half portion B2 between the left and right temporal bones B4, B4′ and is defined by an area between the superior nuchal line D2 of the nuchal lines and the frontal muscle M4 and areas of the left and right temporal bones B4, B4′. To be more specific, as shown in FIG. 4, in the therapy performed in the second zone C2, stimulus treatment is performed by setting a distance at which the protrusions are brought into contact with front and rear meridians scattered in the longitudinal directions in the area in the second zone C2 as a distance between the front ends of the bifurcated treatment portion 3.

In such a state, the treatment device is used such that an axial direction of a pressing stress of the grip portion 2 is directed in a direction perpendicular to the second zone of the head cranial bone of a patient in a face-down state. That is, the axial direction of the pressing stress of the grip portion 2 is directed in a direction which approximately horizontally traverses the second zone of the head of the human body in a standing state.

That is, corresponding to a distance between front and rear meridians scattered in each longitudinal direction within the area in the second zone C2, treatment is performed in a state where, in the longitudinal direction of the cranial bone, the upper protrusion 5 of the bifurcated treatment portion 3 is brought into contact with an epicranial aponeurosis M2 vertex region side, and the lower protrusion 6 of the bifurcated treatment portion 3 is brought into contact with an epicranial aponeurosis M2 occipital region side, an epicranial aponeurosis M2 occipital region side, or an occipital muscle M3.

In positioning the treatment places, as shown in FIG. 4, firstly, the subcutaneous tissue therapy treatment device A is moved toward a vertex region side (in a direction indicated by a broken-line arrow in the second zone in FIG. 4) in a state where the front end 5a of the upper protrusion 5 of the bifurcated treatment portion 3 is brought into pressure contact with meridians of the epicranial aponeurosis M2 positioned on a vertex region side so that the upper protrusion 5 applies a tension to the epicranial aponeurosis M2 or the occipital muscle M3.

Next, by pressing and bringing the lower protrusion 6 into pressure contact with the epicranial aponeurosis M2 or the occipital muscle M3 in a tensioned state in the second zone, the meridians distributed in the respective zones can be gripped by the upper and lower protrusions 5, 6 of the bifurcated treatment portion 3 with certainty.

Further, in performing the therapy in the second zone, the traverse treatment is applied to the surface curved area of the second zone C2 by laterally moving the bifurcated treatment portion 3 little by little in the lateral direction such that the bifurcated treatment portion 3 traverses the front and rear meridians scattered in each longitudinal direction within the area of the second zone C2.

However, it is also possible to selectively apply treatment to only predetermined points in place of such traverse treatment when necessary. The predetermined treatment points are points which conform to effective subcutaneous tissue treatment along meridians (acupuncture points) in the second zone C2. The positions of the treatment points are selectively specified based on finding and experience of a therapist.

Further, in performing the therapy in the second zone, at respective points in the surface curved area, the upper protrusion 5 of the bifurcated treatment portion 3 applies a pressing stress to meridians distributed in the epicranial aponeurosis M2 on a vertex region side, and the lower protrusion 6 of the bifurcated treatment portion 3 applies a pressing stress to the meridians distributed in the epicranial aponeurosis M2 on an occipital region side or a frontal region side or the occipital muscle M3. Such applying of a pressing stress is performed alternately or simultaneously.

Particularly, in applying a pressing stimulus to the meridians distributed in the epicranial aponeurosis M2 on a vertex region side by the upper protrusion 5 of the bifurcated treatment portion 3 and in applying a pressing stimulus to the meridians distributed in the epicranial aponeurosis M2 on an occipital region side or a frontal region side or in the occipital muscle M3 by the lower protrusion 6 of the bifurcated treatment portion 3, as described with reference to the first zone, as shown in FIG. 21, firstly, the bifurcated treatment portion 3 applies a pressing stimulus using the front end 5a of the shorter upper protrusion 5 as a fulcrum and the front end 6b of the longer lower protrusion 6 as a point of action and, subsequently, as an opposite case, the bifurcated treatment portion 3 applies a pressing stimulus using the longer lower protrusion 6 as a fulcrum and the front end 5a of the upper protrusion 5 as a point of action thus performing the treatment such that the bifurcated treatment portion 3 traverses the head while changing a pressing stimulus applying point such that the upper and lower protrusions 5, 6 alternately function as a pressing fulcrum and a pressing point of action.

Next, in the third zone C3, pressing is applied to a surface curved area defined by the frontal muscle M4 portion which covers the calvaria front half portion B3 between the left and right temporal bones. That is, a pressing stimulus applying treatment is performed using a distance at which the longer lower protrusion is brought into contact with the meridians in the third zone C3 while displacing the shorter upper protrusion along the boundary line D4 between the second zone C2 and the third zone C3 as the distance between front ends of the bifurcated treatment portion 3.

To be more specific, as shown in FIG. 5, the bifurcated treatment portion 3 grasps the meridians such that the upper protrusion front end 5a is brought into contact with the meridians distributed on the boundary line D3 between the second zone C2 and the third zone C3 (a boundary between the epicranial aponeurosis M2 and the frontal muscle M4), and the lower protrusion front end 6a is brought into contact with the meridians distributed on the frontal muscle M4 in the third zone C3.

In positioning the treatment places, in the same manner as the first zone and the second zone, as shown in FIG. 5, firstly, the subcutaneous tissue therapy treatment device A is moved upward toward a vertex region side in a state where the upper protrusion front end 5a of the bifurcated treatment portion 3 is brought into pressure contact with the boundary line D3 between the second zone and the third zone so as to apply a tension to the frontal muscle M4 in the third zone such that the frontal muscle M4 is pulled up toward the vertex region side.

Next, by bringing the lower protrusion 6 into pressure contact with the frontal muscle M4 in a tensioned state in the third zone C3, the subcutaneous tissue therapy treatment device A can grasp with certainty both the meridians distributed on the boundary line D3 between the second zone C2 and the third zone C3 and the third zone C3 such that the meridians are grasped by the bifurcated treatment portion 3.

In such a state, the subcutaneous tissue therapy treatment device A is used such that an axial direction of the pressing stress of the gripping portion 2 is directed in the direction perpendicular to the third zone C3 of the head cranial bone of a patient in a face-up state, that is, in a direction which horizontally traverses the third zone of a head of a human body in a standing state. That is, treatment is performed by placing the bifurcated treatment portion 3 to an affected part such that the bifurcated treatment portion 3 strides over the meridians on the boundary line D3 between the second zone C2 and the third zone C3 and the meridians on the frontal muscle M4 in the third zone C3.

Further, particularly, in the therapy in the third zone, the bifurcated treatment portion 3 is made to traverse the vertex region while performing lateral movement little by little in the lateral direction along a distance at which the longer lower protrusion 6 is brought into contact with the meridians in the third zone C3 while displacing the shorter upper protrusion 5 along the boundary line D3 between the second zone C2 and the third zone C3.

However, it is also possible to selectively apply treatment to only predetermined points in place of such traverse treatment when necessary. The predetermined treatment points are points which conform to effective subcutaneous tissue treatment along meridians in the third zone. The positions of the treatment points are selectively specified based on finding and experience of a therapist R.

Further, in performing the therapy in the third zone, at respective points in the second zone C2 and the third zone C3, as shown in FIG. 21, the upper protrusion 5 and the lower protrusion 6 of the bifurcated treatment portion 3 respectively apply a pressing stress alternately or simultaneously.

Particularly, in applying a pressing stimulus to the boundary line D3 between the second zone C2 and the third zone C3 by the upper protrusion 5 of the bifurcated treatment portion 3 and applying a pressing stimulus to the frontal muscle M4 in the third zone by the lower protrusion 6, in the same manner as the cases described with respect to the first and second zones, firstly, a pressing stimulus is applied using the shorter upper protrusion front end 5a as a fulcrum and the lower protrusion front end 6a as a point of action, and, subsequently, as an opposite case, the bifurcated treatment portion 3 applies a pressing stimulus using the longer lower protrusion front end 6a as a fulcrum and the upper protrusion 5 as a point of action thus performing the treatment while changing a pressing stimulus applying point such that the upper and lower protrusions 5, 6 alternately function as a pressing fulcrum and a pressing point of action.

Next, in the fourth zone C4, as shown in FIG. 6, pressing of a surface curved area defined by the temporal muscles M5, M5′ portions which cover the left and right temporal bones B4, B4′ is performed. That is, in the therapy in the fourth zone C4, a stimulus therapy is performed on left and right sides using a distance at which the longer lower protrusion 6 is brought into contact with the meridians in the fourth zone C4 while displacing the shorter upper protrusion 5 along the boundary line D4 between the second zone C2 and the fourth zone C4 as the distance between the front ends of the bifurcated treatment portion 3.

To be more specific, the meridians distributed in the respective areas are grasped by bringing the upper protrusion front end 5a of the bifurcated treatment portion 3 into contact with the meridians distributed on the boundary line D4 between the second zone C2 and the fourth zone C4 (the boundary between the epicranial aponeurosis M2 and the temporal muscle M5) and by bringing the lower protrusion front end 6a into contact with the meridians distributed in the frontal muscle M4 of the fourth zone C4.

In positioning the treatment places, in the same manner as the first to third zones, as shown in FIG. 6, firstly, the subcutaneous tissue therapy treatment device A is moved upward toward a vertex region side in a state where the upper protrusion front end 5a of the bifurcated treatment portion 3 is brought into pressure contact with the boundary line D4 between the second zone C2 and the fourth zone C4 so as to apply a tension to the temporal muscle M5 in the fourth zone C4 such that the temporal muscle M5 is pulled up toward the vertex region side.

Next, by bringing the lower protrusion 6 into pressure contact with the temporal muscle M5 in a tensioned state in the fourth zone C4, the subcutaneous tissue therapy treatment device A can grasp with certainty both the meridians distributed on the boundary line D4 between the second zone C2 and the fourth zone C4 and the fourth zone C4 such that the meridians are grasped by the bifurcated treatment portion 3.

In such a state, the subcutaneous tissue therapy treatment device A is used such that an axial direction of the pressing stress of the gripping portion 2 is directed in the direction perpendicular to the fourth zone C4 of the head cranial bone of a patient in a head side down state, that is, in a direction which horizontally traverses the fourth zone of a head of a human body in a standing state. That is, treatment is performed by placing the bifurcated treatment portion 3 to an affected part such that the bifurcated treatment portion 3 strides over the meridians on the boundary line D4 between the second zone C2 and the fourth zone C4 and the meridians on the temporal muscle M5 in the fourth zone C4.

Particularly, in the therapy in the fourth zone C4, the bifurcated treatment portion 3 is made to traverse the vertex region in the longitudinal direction toward a front side or a rear side little by little along a distance at which the longer lower protrusion 6 is brought into contact with the meridians in the fourth zone C4 while displacing the shorter upper protrusion 5 along the boundary line D4 between the second zone C2 and the fourth zone C4.

However, when necessary, it is also possible to selectively apply treatment to only predetermined points in place of such traverse treatment. The predetermined treatment points are points which conform to effective subcutaneous tissue treatment along meridians in the fourth zone C4. The positions of the treatment points are selectively specified based on finding and experience of a therapist R.

Further, in performing the therapy in the fourth zone, at respective points in the second zone C2 and the fourth zone C4, the upper protrusion 5 and the lower protrusion 6 of the bifurcated treatment portion 3 respectively apply a pressing stress alternately or simultaneously.

Particularly, in applying a pressing stimulus to the boundary line D4 between the second zone C2 and the fourth zone C4 by the upper protrusion 5 of the bifurcated treatment portion 3 and in applying a pressing stimulus to the temporal muscle M5 in the fourth zone by the lower protrusion 6, firstly, a pressing stimulus is applied using the shorter upper protrusion front end 5a as a fulcrum and the lower protrusion front end 6a as a point of action, and, subsequently, as an opposite case, the bifurcated treatment portion 3 applies a pressing stimulus using the longer lower protrusion front end 6a as a fulcrum and the upper protrusion 5 as a point of action thus performing the treatment by changing a pressing stimulus applying point such that the upper and lower protrusions 5, 6 alternately function as a pressing fulcrum and a pressing point of action.

The treatment by the bifurcated treatment portion 3 is performed in the respective areas ranging from the first zone to the fourth zone as described above. In such treatment, in using the treatment device body 1, a therapist grips the grip portion 2 having a bulged large thick wall portion shape with his left palm, and applies the bifurcated treatment portion 3 to a head of a patient with his face down in a direction perpendicular to the head.

Simultaneously, the therapist presses the bifurcated treatment portion 3 to a head of the patient by way of the grip portion 2 with his left hand while pressing the grip portion 2 from a rear end direction by bringing a palm of his right hand to the rear end of the grasp portion 4 formed on the proximal portion of the bifurcated treatment portion 3, for example, the T-shaped lateral side portion of the grasp portion thus applying a therapeutic stimulus to predetermined subcutaneous tissues.

Further, the upper protrusion 5 of the bifurcated treatment portion 3 is made to protrude along an axial direction of the grip portion 2, and the lower protrusion is provided with an inclination of approximately 40° to 60° with respect to the axial direction of the grip portion. Accordingly, a pressing stress generated when the treatment device body 1 is pressed in a direction perpendicular to the respective zones and the pressing stress is applied in the axial direction of the gripping portion 2 can be properly transmitted to an affected part more uniformly by way of the upper and lower protrusions 5, 6 thus applying a stimulus to the meridians or the like of the subcutaneous tissues in the areas of the respective zones.

Further, the therapeutic device body 1 is made of a resin, the roughened surface 30 is formed such that a slide friction of a functional surface of the bifurcated treatment portion 3 is increased, the bifurcated treatment portion 3 is gradually sharpened toward the distal end, and a most distal end portion is formed in a round shape as viewed in a plan view, and in a shape where distal ends are gradually decreased as viewed in a side view. Accordingly, when the treatment device body 1 is operably used such that the bifurcated treatment portion 3 is pressed to an affected part such that the upper and lower protrusions 5, 6 having different lengths alternately perform respective functions as a fulcrum and a point of action, the treatment device body 1 can perform an accurate pressure operation with a considerable weight. Further, there is no possibility that the upper and lower protrusion front ends 5a, 6a which form a fulcrum and a point of action slide so that these front ends 5a, 6a are displaced from an affected part and hence, the treatment device body 1 can apply an effective stimulus action to the subcutaneous tissues with certainty whereby a current disease therapy treatment by a subcutaneous tissue stimulus can be realized.

A T-shaped lateral side portion of the curved grasp portion 4 can be used for applying a pressing stimulus to subcutaneous tissues of the proximal portion of the neck.

The upper and lower protrusions 5, 6 of the bifurcated treatment portion 3 may be formed in a flat shape, and a center portion of a flat distal end edge in a wall thickness direction is formed in a recessed shape thus forming both left and right side protruding edge portions 5b, 5c, 6b, 6c on both flat side surfaces. In this case, a friction resistance is increased corresponding to the increase of the number of skin contact points on the surface of the cranial bone and hence, the subcutaneous tissue therapy treatment device A can apply a stable pressing force to an affected part.

### 3. Measurement of Surface Roughness in Subcutaneous Tissue Therapy Treatment Device

Next, the following test was carried out on the subcutaneous tissue therapy treatment device according to this embodiment with respect to surface roughness of a roughened surface formed on a functional surface of the bifurcated treatment portion.

As the subcutaneous tissue therapy treatment device subjected to the test, a subcutaneous tissue therapy treatment device where a roughened surface was formed on functional surfaces of the upper and lower protrusion front ends of a bifurcated treatment portion by sand blasting and a subcutaneous tissue therapy treatment device where a roughened surface having fine unevenness was formed on upper and lower protrusion front ends in a vertical direction by a 3D printer were used. For a comparison purpose, a Kassa plate formed in a flat shape by molding using hard plastic and had a plurality of pressing protruding portions on an edge of the Kassa plate was subjected to measurement.

The measurement of the roughened surface on the bifurcated treatment portion of the subcutaneous tissue therapy treatment device was performed using a multi-purpose surface roughness, profile and shape measuring instrument (Surfcom5000DX made by TOKYO SEIMITSU Co., Ltd.). The measurement was performed by making a probe of the measuring instrument trace surfaces of the upper and lower protrusions as viewed in a plan view, wherein the probe traced the surface from the outside to a bifurcated valley portion plural times (five times) and from the bifurcated valley portion to the outside plural times (five times). The surface roughness was measured as an arithmetic average height (Ra) in accordance with JIS B6001-2001. In the same manner, the measurement of a surface roughness of the Kassa plate for a comparison purpose was performed in accordance with the above-mentioned method with modification and the surface roughness Ra was measured.

As a result, it was found that the surface roughness Ra of the roughened surface of the bifurcated treatment portion of the subcutaneous tissue therapy treatment device fell within a range of from 10 μm to 35 μm, particularly mainly within a range of from 15 μm to 30 μm. Further, an external appearance of the subcutaneous tissue therapy treatment device exhibited a dusky color attributed to the roughened surface of the whole treatment device body.

On the other hand, the subcutaneous tissue therapy treatment device made of Kassa plate provided for a comparison purpose had a luster external appearance, and the surface roughness of the Kassa plate exhibited a small value. That is, the surface roughness Ra of the Kassa plate fell within a range of from 0.04 μm to 0.2 μm.

As such a result, the following was suggested. In the subcutaneous tissue therapy treatment device according to this invention, convex portions attributed to the roughened surface having the surface roughness Ra of from 10 μm to 35 μm bite into skin tissues of an affected part so that the roughened surface grasps the skin surface without sliding on the skin surface whereby the subcutaneous tissue therapy treatment device was brought into a stable state. Accordingly, the subcutaneous tissue therapy treatment device can directly apply a pressing force to a subcutaneous tissue from the convex portion and can apply a pressing stimulus to a useful functional part of a human body and hence, a chiropractic treatment effect was enhanced.

### 4. Evaluation on Subcutaneous Tissue Therapy Treatment Device

Next, the evaluation of the subcutaneous tissue therapy treatment device was performed. As the subcutaneous tissue therapy treatment device subjected to the evaluation, a treatment device S1 which was not subjected to roughening treatment, a treatment device S2 which was subjected to roughening treatment having a surface roughness Ra of 10 μm to 35 μm, and the Kassa plate for a comparison purpose provided in [3. Measurement of surface roughness in subcutaneous tissue therapy treatment device] for a comparison purpose were used.

The evaluation of the subcutaneous tissue therapy treatment device was performed separately based on the evaluation from a viewpoint of operability of the therapist and the evaluation from a viewpoint of therapy receiving feeling of a patient in the case where the pressing treatment is performed using respective devices in accordance with [2. Clinical example in which subcutaneous tissue therapy treatment device is used].

The evaluation from a viewpoint of operability of the therapist was made such that each of five therapists comprehensively determined stability feeling and gripping feeling of the device on a surface of a scalp of the patient whom the therapist is in charge of, and made the evaluation based on five-grade evaluation. It was determined that the larger the numeral is, the higher impression of stability and the higher impression of gripping property the therapist has. The result of the evaluation is shown in Table 1.

TABLE 1

| | Treatment | Treatment | Kassa for |
|---|---|---|---|
| | device S1 | device S2 | a comparison purpose |
| Therapist A | 4 | 5 | 1 |
| Therapist B | 5 | 5 | 2 |
| Therapist C | 4 | 4 | 1 |
| Therapist D | 4 | 4 | 1 |
| Therapist E | 4 | 5 | 1 |
| Average | 4.2 | 4.6 | 1.2 |

As can be understand from Table 1, it is proved that the therapists had an impression that both the treatment device S1 and the treatment device S2 had the higher stability and the higher gripping property compared to the Kassa for a comparison purpose.

Some therapists replied that the treatment device S2 to which roughening treatment was applied exhibits favorable stability and favorable gripping property during treatment compared to the treatment device S1 to which roughening treatment was not applied so that the therapists could easily perform pressing therapy with no discomfort and with a less pressing stress with the use of the treatment device S2.

Next, the evaluation from a viewpoint of therapy receiving feeling of patients was performed. The evaluation from a viewpoint of therapy receiving feeling of patients was made such that each of five patients whom the five therapists were respectively in charge of comprehensively determined the feeling transmitted from the distal end of the device, that is, the feeling of being grasped by the protruding portions of the device, the tension applied feeling of a scalp when the scalp was stretched by the device, and pressing applied feeling applied to the scalp by the device and made the evaluation based on five-grade evaluation. It was determined that the larger the numeral is, the higher the therapy receiving feeling such as the feeling that a scalp is grasped, the tension applied feeling or pressing applied feeling the patients have. The result of the evaluation is shown in Table 2.

TABLE 2

| | Treatment | Treatment | Kassa for |
|---|---|---|---|
| | device s1 | device s2 | a comparison purpose |
| Patient a | 5 | 5 | 2 |
| Patient b | 4 | 5 | 1 |
| Patient c | 4 | 4 | 1 |
| Patient d | 4 | 5 | 1 |
| Patient e | 5 | 5 | 2 |
| Average | 4.4 | 4.8 | 1.4 |

As can be also understood from Table 2, it was proved that, in the same manner as the evaluation from a viewpoint of operability of the therapists, the treatment device S1 and the treatment device S2 allowed the patients to have a high therapy receiving impression compared to a Kassa for a comparison purpose.

Some patients replied that the treatment device S2 to which roughening treatment was applied brought a feeling as if a scalp in a zone is pressed in a state where the scalp is grasped by fingers of a therapist when the bifurcated treatment portion is brought into pressure contact with a surface of the scalp compared to the treatment device S1 to which roughening treatment was not applied.

As has been described heretofore, the evaluations suggested that the subcutaneous tissue therapy treatment device according to this embodiment fundamentally differs from “Kassa plate” known as a conventional massage device which obtains a massaging effect by simply performing conventional roles such as “pressing” and “rubbing”. That is, the subcutaneous tissue therapy treatment device according to this embodiment performs “pressing”, “rotating” and “pulling” “a skin under a stretched state” and hence, tissues under the scalp are compressed without moving away from the pressing direction.

Particularly, it was found that, in the subcutaneous tissue therapy treatment device, by forming the roughened surface on a functional surface of the bifurcated treatment portion so as to increase a slide friction, a scalp can be grasped together with subcutaneous tissues, and the bifurcated treatment portion can be pressed and turned in a state where the scalp is stretched at maximum to press the tissues.

In this manner, the subcutaneous tissue therapy treatment device according to this invention can perform treatment by applying a pressing stimulus to an affected part while tracing a spherical surface of the cranial bone by the bifurcated treatment portion. Further, a direction along which a largest pressing stress is applied to the cranial bone is set to a direction perpendicular to a head of a patient in a face-down state. That is, in a state where the head of the patient in a standing posture is divided into four zones in a horizontal direction of the head and a stimulus therapy can be applied to subcutaneous tissues in the four zones of the cranial bone ranging from a rear surface portion to a vertex region.

Finally, the above-mentioned respective embodiments is exemplified as one example of this invention, and it is needless to say that various modifications can be made corresponding to designs even when the modification do not belong the above-mentioned respective embodiments provided that the modifications fall within the technical concept of the present invention.

### REFERENCE SIGNS LIST

A: subcutaneous tissue therapy treatment device
1: treatment device body
2: grip portion
3: bifurcated treatment portion
4: grasp portion
5: upper protrusion
6: lower protrusion

1. A subcutaneous tissue therapy treatment device, wherein
a treatment device body is formed of: a grip portion; a bifurcated treatment portion for a neck and a head which is formed on a distal end of the grip portion; and a grasp portion which is formed on a rear end of the grip portion, and the bifurcated treatment portion for a neck and a head is formed by combining a lower protrusion positioned closer to the neck during treatment and an upper protrusion positioned closer to a vertex region during treatment to each other,
an upper protrusion front end and a lower protrusion front end of the bifurcated treatment portion are formed with a distance which allows fixed placement of the upper protrusion front end and the lower protrusion front end striding over both side edge lines of respective zones in a case where a surface of a cranial bone is divided into four zones ranging from an occipital region to a frontal region, and
in a state where, out of the four zones defined by dividing the cranial bone ranging from the occipital region to frontal region,
assuming a surface curved area which is a suboccipital muscles portion which covers a cranial base between left and right temporal bones in layers and is positioned between an inferior nuchal line of nuchal lines and a superior nuchal line of the nuchal lines as a first zone formed by dividing the surface of the cranial bone,
assuming a surface curved area which is an occipital muscle portion and an epicranial aponeurosis portion which cover a calvaria rear half portion between the left and right temporal bones and is defined by respective areas consisting of an area between the superior nuchal line of the nuchal lines and the frontal muscle and an area between the left and right temporal bones as a second zone formed by dividing the surface of the cranial bone,
assuming a surface curved area which is defined by a frontal muscle portion which covers a calvaria front half portion between the left and right temporal bones as a third zone formed by dividing the surface of the cranial bone, and
assuming a surface curved area which is defined by temporal muscle portions which cover the left and right temporal bones as a fourth zone formed by dividing the surface of the cranial bone,
a distance between the upper and lower protrusion front ends of the bifurcated treatment portion satisfies respective distances consisting of:
a distance where the distance strides over a boundary line between the first zone and the second zone, the lower protrusion is brought into contact with a meridian in the first zone and the upper protrusion is brought into contact with the meridian in the second zone; a distance where the upper and lower protrusions are brought into contact with the front and rear meridians scattered in respective longitudinal directions in an area of the second zone; a distance where the lower protrusion is brought into contact with the meridian in the third zone while displacing the upper protrusion along a boundary line between the second zone and the third zone; a distance where the lower protrusion is brought into contact with the meridian in the fourth zone while displacing the upper protrusion along a boundary line between the second zone and the fourth zone and the like.

2. The subcutaneous tissue therapy treatment device according to claim 1, wherein the lower protrusion of the bifurcated treatment portion is formed in a shape protruding longer in a distal end direction than the upper protrusion, and the distance between the upper and lower protrusion front ends of the bifurcated treatment portion satisfies respective distances consisting of:
a distance where the distance strides over a boundary line between the first zone and the second zone, the longer lower protrusion is brought into contact with the meridian in the first zone and the shorter upper protrusion is brought into contact with the meridian in the second zone; a distance where the upper and lower protrusions are brought into contact with the front and rear meridians scattered in the respective longitudinal directions in an area of the second zone; a distance where the longer lower protrusion is brought into contact with the meridian in the third zone while displacing the shorter upper protrusion along a boundary line between the second zone and the third zone; a distance where the longer lower protrusion is brought into contact with the meridian in the fourth zone while displacing the shorter upper protrusion along a boundary line between the second zone and the fourth zone and the like.

3. The subcutaneous tissue therapy treatment device according to claim 1, wherein the upper protrusion of the bifurcated treatment portion is made to protrude along an axial direction of the grip portion, and the lower protrusion is provided with an inclination of approximately 40° to 60° with respect to the axial direction of the grip portion.

4. The subcutaneous tissue therapy treatment device according to claim 1, wherein the upper and lower protrusions of the bifurcated treatment portion are formed in a flat shape, and a center portion of a flat distal end edge in a wall thickness direction is formed in a recessed shape thus forming both left and right side protruding edge portions on both flat side surfaces.

5. The subcutaneous tissue therapy treatment device according to claim 1, wherein the subcutaneous tissue therapy treatment device is configured such that when a therapist grips the grip portion having a rod shape between the bifurcated treatment portion and the grasp portion using a length of the grip portion as a width of a palm gripping part of the therapist, both end surfaces of the palm gripping part in a width direction are brought into close contact with the bifurcated treatment portion and the grasp portion.

6. The subcutaneous tissue therapy treatment device according to claim 1, wherein the bifurcated treatment portion is gradually sharpened toward the distal end, and a most distal end portion is formed in a round shape as viewed in a plan view and in a shape where wall thickness is gradually decreased toward the distal end as viewed in a side view.

7. The subcutaneous tissue therapy treatment device according to claim 1, wherein a roughened surface which increases a slide friction is formed on a functional surface of the bifurcated treatment portion formed on the front end of the grip portion.

8. The subcutaneous tissue therapy treatment device according to claim 1, wherein the subcutaneous tissue therapy treatment device is configured such that the treatment device body is made of a resin, and is capable of performing stable treatment while maintaining a considerable weight during a treatment operation.
